(19) United States
(12) Patent Application Publication
(10) Pub. No.: US 2025/0030963 A1
(43) Pub. Date: Jan. 23, 2025

(54) IMAGING DEVICE AND IMAGING METHOD

(71) Applicant: Panasonic Intellectual Property Management Co., Ltd., Osaka (JP)

(72) Inventors: YASUO MIYAKE, Osaka (JP); MORIO MITSUISHI, Kanagawa (JP)

(21) Appl. No.: 18/905,137

(22) Filed: Oct. 2, 2024

Related U.S. Application Data
(63) Continuation of application No. PCT/JP2023/008438, filed on Mar. 7, 2023.

(30) Foreign Application Priority Data
Apr. 21, 2022 (JP) 2022-070187

(51) Int. Cl. H04N 25/772; H04N 25/57

(52) U.S. Cl. CPC H04N 25/772; H04N 25/57

(57) ABSTRACT

An imaging device includes a pixel that includes a photoelectric converter converting light into a signal charge and a charge accumulator accumulating the signal charge and outputs a pixel signal according to an amount of the signal charge accumulated in the charge accumulator, an AD conversion circuit performing AD conversion of the pixel signal output from the pixel, and a control circuit setting the number of gradations of digital output of the AD conversion. The photoelectric converter has photoelectric conversion characteristics such that photoelectric conversion efficiency changes according to a potential difference between a counter electrode and a pixel electrode. Linearity of a magnitude of the pixel signal with respect to an amount of light incident on the photoelectric converter changes depending on a voltage VITO supplied from a voltage supply circuit to the pixel. The control circuit changes the number of gradations in accordance with the voltage VITO.

### BACKGROUND

### 1. Technical Field

The present disclosure relates to an imaging device and an imaging method.

### 2. Description of the Related Art

In the imaging device field, a configuration in which, instead of a photodiode, a photoelectric conversion layer is disposed above a semiconductor substrate on which a readout circuit is provided is known. Such a configuration is known as a stacked type. For example, Japanese Unexamined Patent Application Publication No. 2011-228648 discloses an imaging element that has an organic photoelectric conversion layer sandwiched between a pixel electrode and a transparent counter electrode above a substrate on which a readout circuit is provided. In Japanese Unexamined Patent Application Publication No. 2011-228648, a predetermined voltage is applied to the counter electrode during operation of the imaging device.

U.S. Pat. No. 9,054,246 discloses an imaging system having a quantum-dot layer as a photoelectric conversion layer. U.S. Pat. No. 9,054,246 also discloses adjusting gain of the quantum-dot layer by changing a potential difference applied between a transparent electrode and a pixel electrode that sandwich the quantum-dot layer.

Japanese Unexamined Patent Application Publication No. 2019-176463 discloses enlarging a dynamic range by changing a bias voltage applied to a photoelectric conversion layer in accordance with a level of an output signal.

### SUMMARY

There are demands for an imaging device and others that have a wide dynamic range while suppressing degradation of a signal/noise (S/N) ratio.

In one general aspect, the techniques disclosed here feature an imaging device including a pixel that includes a photoelectric converter that converts light into a signal charge and a charge accumulator that accumulates the signal charge and outputs a pixel signal according to an amount of the signal charge accumulated in the charge accumulator; an AD conversion circuit that performs AD conversion of the pixel signal output from the pixel; and a control circuit that sets the number of gradations of digital output of the AD conversion of the pixel signal performed by the AD conversion circuit, in which the photoelectric converter includes a counter electrode, a pixel electrode connected to the charge accumulator, and a photoelectric conversion layer located between the counter electrode and the pixel electrode, the photoelectric converter has photoelectric conversion characteristics such that photoelectric conversion efficiency changes according to a potential difference between the counter electrode and the pixel electrode, linearity of a magnitude of the pixel signal with respect to an amount of light incident on the photoelectric converter changes depending on a first voltage supplied from a voltage supply circuit to the pixel, and the control circuit changes the number of gradations in accordance with the first voltage.

According to the aspect of the present disclosure, it is possible to provide an imaging device and others that have a wide dynamic range while suppressing degradation of a signal/noise (S/N) ratio.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is an exemplary schematic circuit diagram of an imaging device according to Embodiment 1;

FIG. 2 illustrates an exemplary circuit configuration of a pixel according to Embodiment 1;

FIG. 3 is a schematic cross-sectional view illustrating an example of a device structure of the pixel according to Embodiment 1;

FIG. 4 is an exemplary energy band diagram in a photoelectric conversion unit according to Embodiment 1;

FIG. 5 is an energy band diagram in a case where a low voltage is applied between a counter electrode and a pixel electrode in the photoelectric conversion unit having the energy band configuration illustrated in FIG. 4;

FIG. 6 is an energy band diagram in a case where a high voltage is applied between the counter electrode and the pixel electrode in the photoelectric conversion unit having the energy band configuration illustrated in FIG. 4;

FIG. 7A illustrates an example of schematic photoelectric conversion characteristics of the photoelectric conversion unit according to Embodiment 1;

FIG. 7B schematically illustrates a relationship between a pixel signal output and an exposure amount in a pixel including a photoelectric conversion unit having the photoelectric conversion characteristics illustrated in FIG. 7A;

FIG. 8A illustrates another example of schematic photoelectric conversion characteristics of the photoelectric conversion unit according to Embodiment 1;

FIG. 8B schematically illustrates a relationship between a pixel signal output and an exposure amount in a pixel including a photoelectric conversion unit having the photoelectric conversion characteristics illustrated in FIG. 8A;

FIG. 9 is a block diagram illustrating signal processing of the imaging device according to Embodiment 1;

FIG. 10 schematically illustrates an example of a change of an output level of a pixel signal with respect to a change of an amount of light incident on the photoelectric conversion unit according to Embodiment 1;

FIG. 11 is a block diagram schematically illustrating an outline of linearity compensation processing;

FIG. 12 schematically illustrates output values before and after the linearity compensation processing;

FIG. 13 schematically illustrates a change of an output value according to the number of gradations of AD conversion;

FIG. 14 schematically illustrates a change of an output value according to a potential of the counter electrode;

FIG. 15 schematically illustrates operation of converting 16-bit parallel pixel data into serial pixel data in a parallel-serial conversion circuit;

FIG. 16 schematically illustrates operation of converting 12-bit parallel pixel data into serial pixel data in the parallel-serial conversion circuit;

FIG. 17 schematically illustrates an example of operation in a case where a voltage applied to the counter electrode and the number of bits of AD conversion are changed between frames;

FIG. 18 schematically illustrates an example of operation in a case where a voltage applied to the counter electrode, the number of bits of AD conversion, and the number of sensor output bits are changed between frames;

FIG. 19 schematically illustrates an example of operation in a case where a frame rate, a voltage applied to the counter electrode, the number of bits of AD conversion, and the number of sensor output bits are changed between frames;

FIG. 20 schematically illustrates an example of operation in a case where AD conversion is performed linearly on a pixel signal voltage;

FIG. 21 schematically illustrates an example of operation in a case where AD conversion is performed non-linearly on a pixel signal voltage;

FIG. 22 illustrates an exemplary circuit configuration of a pixel according to Embodiment 2;

FIG. 23 schematically illustrates exposure amount-pixel signal output characteristics in a first mode;

FIG. 24 schematically illustrates exposure amount-pixel signal output characteristics in a second mode; and

FIG. 25 is a diagram for explaining adjustment of gamma characteristics.

### DETAILED DESCRIPTIONS

### Underlying Knowledge Forming Basis of the Present Disclosure

The inventors developed a stacked photoelectric conversion unit configuration having novel photoelectric conversion characteristics. In a case where this photoelectric conversion unit configuration is used, linearity of a change of an output signal level with respect to a change of an incident light amount markedly changes depending on a voltage applied to a counter electrode. The inventors found that a dynamic range can be markedly enlarged by actively utilizing a region where the linearity decreases. Furthermore, the inventors arrived at a configuration of the present disclosure that can reduce electric power consumption and enlarge a dynamic range while suppressing degradation of an S/N ratio by setting the number of gradations of Analog-to-Digital (AD) conversion in accordance with a change of the linearity.

An outline of an aspect of the present disclosure is as follows.

An imaging device according to an aspect of the present disclosure includes a pixel that includes a photoelectric converter that converts light into a signal charge and a charge accumulator that accumulates the signal charge and outputs a pixel signal according to an amount of the signal charge accumulated in the charge accumulator; an AD conversion circuit that performs AD conversion of the pixel signal output from the pixel; and a control circuit that sets the number of gradations of digital output of the AD conversion of the pixel signal performed by the AD conversion circuit, in which the photoelectric converter includes a counter electrode, a pixel electrode connected to the charge accumulator, and a photoelectric conversion layer located between the counter electrode and the pixel electrode, the photoelectric converter has photoelectric conversion characteristics such that photoelectric conversion efficiency changes according to a potential difference between the counter electrode and the pixel electrode, linearity of a magnitude of the pixel signal with respect to an amount of light incident on the photoelectric converter changes depending on a first voltage supplied from a voltage supply circuit to the pixel, and the control circuit changes the number of gradations in accordance with the first voltage.

Since the linearity of the magnitude of the pixel signal with respect to the amount of light incident on the photoelectric converter changes depending on the first voltage, for example, a slope of the magnitude of the pixel signal with respect to the amount of incident light can be made small on a high illuminance side by setting the first voltage so that the linearity decreases. Therefore, a dynamic range on a high illuminance side can be enlarged. In a case where the slope of the magnitude of the pixel signal that has been made small is corrected, weight per gradation in the AD conversion is large, and quantization noise increases. In this aspect, however, an output value in the AD conversion can be increased by changing the number of gradations of the AD conversion in accordance with the first voltage. Therefore, the weight per gradation in the AD conversion is reduced, and in a case where the slope of the magnitude of the pixel signal is corrected, influence of the quantization noise is reduced, and degradation of an S/N ratio can be suppressed. Therefore, according to the imaging device according to this aspect, a dynamic range can be enlarged while suppressing degradation of an S/N ratio.

For example, the voltage supply circuit may supply the first voltage to the counter electrode.

With this configuration, the linearity of the magnitude of the pixel signal with respect to the amount of light incident on the photoelectric converter can be changed by the first voltage supplied to the counter electrode.

For example, the pixel may include a transistor, one of a source and a drain of the transistor may be connected to the charge accumulator, and the voltage supply circuit may supply the first voltage to the other one of the source and the drain.

With this configuration, the linearity of the magnitude of the pixel signal with respect to the amount of light incident on the photoelectric converter can be changed by the first voltage supplied to the charge accumulator via the transistor.

For example, the photoelectric converter may have photoelectric conversion characteristics such that a first voltage range, a second voltage range, and a third voltage range characterized by a change of the photoelectric conversion efficiency with respect to the potential difference are present in a reverse bias region, and in the photoelectric conversion characteristics, the first voltage range may be a voltage range immediately before rising of the photoelectric conversion efficiency, the third voltage range may be a voltage range in which the photoelectric conversion efficiency is saturated, and the second voltage range may be a voltage range between the first voltage range and the third voltage range and may be a voltage range in which the photoelectric conversion efficiency increases at a slope larger than the first voltage range and the third voltage range as the potential difference increases.

With this configuration, in the second voltage range, the photoelectric conversion efficiency markedly changes as the potential difference changes, and therefore the linearity of the magnitude of the pixel signal with respect to the amount of light incident on the photoelectric converter can be decreased by using the first voltage that makes the potential difference fall in the second voltage range. It is therefore possible to effectively enlarge a dynamic range.

For example, a width of the first voltage range may be 0.5 V or more.

With this configuration, the width of the first voltage range is large. Therefore, a value of the potential difference in the second voltage range can be made large. Since a maximum amount of signal charge that can be accumulated in the charge accumulator is limited by a magnitude of the potential difference, the maximum amount of signal charge that can be accumulated in the charge accumulator can be increased by increasing the potential difference in the second voltage range. As a result, a maximum amplitude of the pixel signal can be increased in a case where the pixel signal is output by using the first voltage that makes the potential difference fall in the second voltage range.

For example, the control circuit may set the number of gradations in a case where the first voltage that makes the potential difference fall in the second voltage range is supplied to the pixel larger than the number of gradations in a case where the first voltage that makes the potential difference to fall in the third voltage range is supplied to the pixel.

With this configuration, the number of gradations of the AD conversion is increased in a case where the first voltage that makes the potential difference fall in the second voltage range is used, in which case the linearity of the magnitude of the pixel signal with respect to the amount of light incident on the photoelectric converter decreases. This can suppress degradation of an S/N ratio.

For example, the pixel may include a capacitance circuit that changes a capacitance value of the charge accumulator in accordance with a potential of the charge accumulator, and the voltage supply circuit may supply the first voltage to the capacitance circuit. For example, the capacitance circuit may include a transistor and a capacitor that are connected in series between a first wire and the charge accumulator, a gate of the transistor may be electrically connected to the charge accumulator, and the voltage supply circuit may supply the first voltage to the first wire.

With this configuration, the linearity of the magnitude of the pixel signal with respect to the amount of light incident on the photoelectric converter can be changed by the first voltage supplied to the capacitance circuit.

An imaging method using an imaging device according to an aspect of the present disclosure is an imaging method using an imaging device including a pixel that includes a photoelectric converter that converts light into a signal charge and a charge accumulator that accumulates the signal charge and outputs a pixel signal according to an amount of the signal charge accumulated in the charge accumulator and an AD conversion circuit that performs AD conversion of the pixel signal output from the pixel, in which linearity of a magnitude of the pixel signal with respect to an amount of light incident on the photoelectric converter changes depending on a first voltage supplied to the pixel, the imaging method including supplying the first voltage to the pixel; and setting the number of gradations of a digital output of the AD conversion of the pixel signal performed by the AD conversion circuit in accordance with the first voltage.

This can enlarge a dynamic range while suppressing degradation of an S/N ratio, as with the imaging device.

Embodiments are described below with reference to the drawings.

Each of embodiments described below is a general or specific example. Numerical values, shapes, constituent elements, the way in which the constituent elements are disposed and connected, steps, the order of steps, and the like in the embodiments below are examples and do not limit the present disclosure. Among constituent elements in the embodiments below, constituent elements that are not described in independent claims are described as optional constituent elements. Each drawing is not necessarily strict illustration. In the drawings, substantially identical constituent elements are given identical reference signs, and repeated description will be sometimes omitted or simplified.

In the present specification, terms indicating relationships between elements, terms indicating shapes of elements, and numerical value ranges are not expressions expressing only strict meaning, but expressions encompassing substantially equivalent ranges, for example, differences of approximately several %.

In the present specification, terms “upper/upward/above” and “lower/downward/below” do not indicate an upward direction (vertically upward) and a downward direction (vertically downward) in absolute space recognition but are used as terms defined by a relative positional relationship on the basis of a stacking order in a stacked configuration. Note that terms such as ‘upper/upward/above” and “lower/downward/below” are merely used to designate relative positions of members and do not intend to limit a posture of an imaging device during use. Furthermore, the terms ‘upper/upward/above” and “lower/downward/below” are applied not only to a case where two constituent elements are disposed apart from each other with another constituent element interposed therebetween, but also to a case where two constituent elements are disposed in close contact with each other.

### Embodiment 1

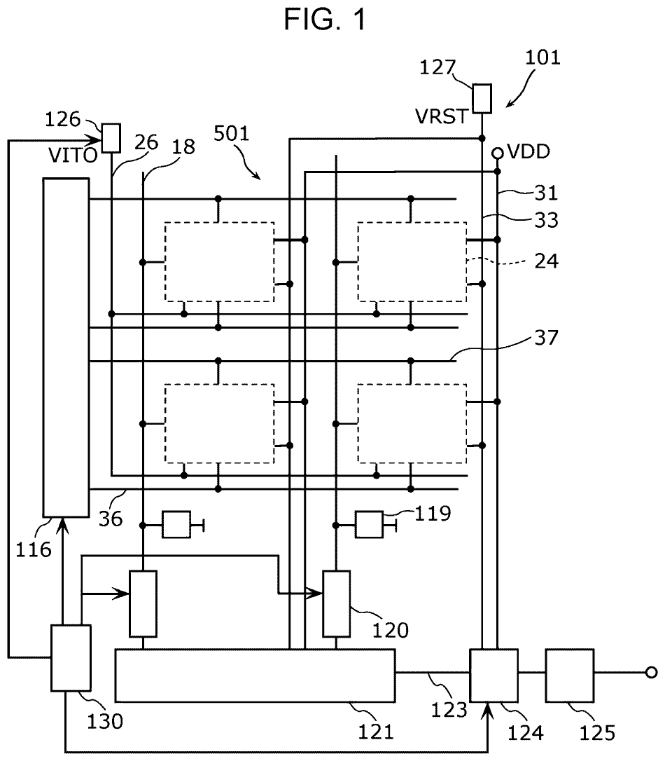

FIG. 1 is an exemplary schematic circuit diagram of an imaging device according to Embodiment 1. As illustrated in FIG. 1, an imaging device 101 includes a plurality of pixels 24 and a peripheral circuit.

The plurality of pixels 24 are two-dimensionally arranged on a semiconductor substrate and thus constitute a pixel array 501. The semiconductor substrate is, for example, a silicon substrate. In the example illustrated in FIG. 1, the plurality of pixels 24 are arranged in a row direction and a column direction. The plurality of pixels 24 may be arranged one-dimensionally to constitute a line sensor.

Each of the pixels 24 is connected to a power supply wire 31. A power-supply voltage VDD is applied to each of the pixels 24 through the power supply wire 31.

The peripheral circuit includes a vertical scanning circuit 116, a load circuit 119, a column signal processing circuit 120, a horizontal signal readout circuit 121, a voltage supply circuit 126, a voltage supply circuit 127, and a control circuit 130. The column signal processing circuit 120 and the load circuit 119 are disposed for each column of the pixels 24.

Each of the pixels 24 includes a photoelectric conversion unit 10A (described later) provided above a semiconductor substrate. A voltage VITO is applied to all photoelectric conversion units 10A through an accumulation control line 26.

Each of the pixels 24 is connected to a reset voltage line 33. A reset voltage VRST is applied to each of the pixels 24 through the reset voltage line 33.

The voltage supply circuit 126 is electrically connected to each of the pixels 24 through the accumulation control line 26. The voltage supply circuit 126 supplies the voltage VITO to each of the pixels 24.

The voltage supply circuit 127 is electrically connected to each of the pixels 24 through the reset voltage line 33. The voltage supply circuit 127 supplies the reset voltage VRST to each of the pixels 24.

The voltage supply circuit 126 and the voltage supply circuit 127 are not limited to specific power-supply circuits, and may be circuits that generate a predetermined voltage or may be circuits that convert a voltage supplied from another power supply into a predetermined voltage. Note that the imaging device 101 may be configured not to include at least one of the voltage supply circuit 126 and the voltage supply circuit 127. For example, at least one of the voltage VITO and the reset voltage VRST may be supplied to each of the pixels 24 from an external power supply.

An address signal line 36 is provided for each row of the pixels 24. The pixels 24 of each row are connected to the vertical scanning circuit 116 through a corresponding address signal line 36. The vertical scanning circuit 116 selects the pixels 24 per row by applying a predetermined voltage to the address signal line 36. In this way, pixel signals of the selected pixels 24 are read out.

A reset signal line 37 is provided for each row of the pixels 24. The pixels 24 of each row are connected to the vertical scanning circuit 116 through a corresponding reset signal line 37. ON and OFF of a reset transistor 22 can be controlled by controlling a potential of the reset signal line 37.

A vertical signal line 27 is provided for each column of the pixels 24. The pixels 24 of each column are connected to a corresponding vertical signal line 27.

The load circuit 119 is provided for each vertical signal line 27. Each load circuit 119 is connected to a corresponding vertical signal line 27.

The column signal processing circuit 120 is provided for each vertical signal line 27. Each column signal processing circuit 120 is connected to a corresponding vertical signal line 27. The column signal processing circuit 120 performs processing such as noise suppression signal processing and analog-digital conversion (AD conversion). The noise suppression signal processing is, for example, correlated double sampling (CDS). The column signal processing circuit 120 includes, for example, a CDS circuit and an AD conversion circuit. The plurality of column signal processing circuits 120 are connected to the horizontal signal readout circuit 121. The horizontal signal readout circuit 121 sequentially reads out signals from the plurality of column signal processing circuits 120 to a horizontal common signal line 123.

The imaging device 101 further includes a digital processing unit 124 and an output I/F 125.

Data output from the horizontal common signal line 123 is subjected to digital processing such as optical black (OB) correction, digital gain processing, and data bit length format adjustment by the digital processing unit 124 and is then output to the output I/F 125.

The data input to the output I/F 125 is output as small-amplitude high-speed serial data such as MIPI D-phy, Sub-LVDS, or SLVS-EC.

The control circuit 130 controls the whole imaging device 101. For example, the control circuit 130 generates various kinds of control signals for controlling circuits included in the imaging device 101 and supplies the control signals to the circuits. Note that although a single control circuit 130 that controls the whole imaging device 101 is provided in the example illustrated in FIG. 1, the control circuit 130 may be distributed corresponding to at least one circuit included in the circuits included in the imaging device 101.

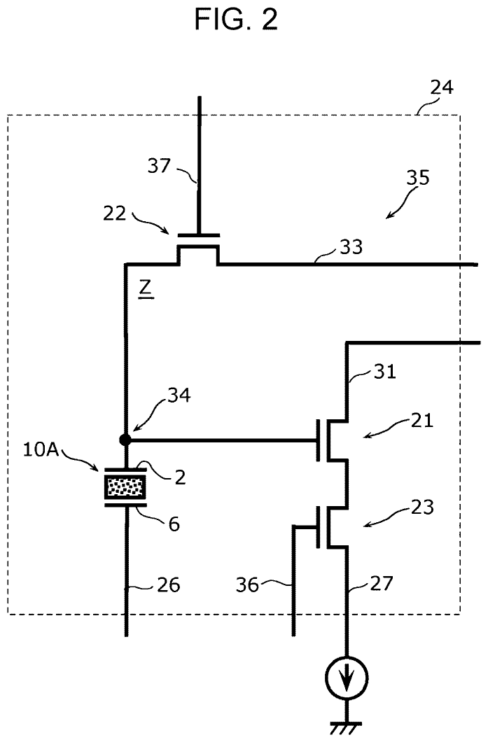

FIG. 2 illustrates an exemplary circuit configuration of the pixels 24 according to the present embodiment.

As illustrated in FIG. 2, each of the pixels 24 includes the photoelectric conversion unit 10A and a charge accumulation unit Z. The photoelectric conversion unit 10A converts light into a charge. Hereinafter, this charge is sometimes referred to as a signal charge. The charge accumulation unit Z accumulates the signal charge. The pixel 24 outputs a pixel signal according to an amount of signal charge accumulated in the charge accumulation unit Z.

In the present embodiment, the photoelectric conversion unit 10A includes a counter electrode 6, a pixel electrode 2, and a photoelectric conversion layer 4, which will be described later. Details of the photoelectric conversion unit 10A will be described later.

The counter electrode 6 is connected to the accumulation control line 26. The voltage VITO is applied to the counter electrode 6 through the accumulation control line 26. In this way, a hole or an electron of a hole-electron pair generated by photoelectric conversion in the photoelectric conversion layer 4 can be collected as a signal charge by the pixel electrode 2.

In a case where a hole is used as a signal charge, the voltage VITO is set so that a potential of the counter electrode 6 becomes higher than a potential of the pixel electrode 2 during exposure. For example, the voltage VITO is set higher than the reset voltage VRST. For example, 0 V or a voltage close to 0 V is used as the reset voltage VRST. The following describes a case where a hole is used as a signal charge. Note, however, that an electron may be used as a signal charge. In this case, the voltage VITO is set so that the potential of the counter electrode 6 becomes lower than the potential of the pixel electrode 2 during exposure.

The pixel electrode 2 is connected to a charge accumulation node 34. In the present specification, the charge accumulation node 34 is a part of the charge accumulation unit Z that accumulates a signal charge collected by the pixel electrode 2. The charge accumulation unit Z includes a part of an electrode, a part of a transistor, a part of a capacitive element, and the like connected to the charge accumulation node 34. In the present specification, an electrode, a transistor, a capacitive element, and the like connected to the charge accumulation node 34 and having a part included in the charge accumulation unit Z means an electrode, a transistor, a capacitive element, and the like connected to the charge accumulation unit Z.

The pixel 24 includes a signal detection circuit 35. The signal detection circuit 35 includes an amplification transistor 21, an address transistor 23, and a reset transistor 22.

One of a source and a drain of the reset transistor 22 is connected to the charge accumulation node 34. The other one of the source and the drain of the reset transistor 22 is connected to the reset voltage line 33.

A gate of the amplification transistor 21 is connected to the charge accumulation node 34. One of a source and a drain of the amplification transistor 21 is connected to the power supply wire 31. The other one of the source and the drain of the amplification transistor 21 is connected to one of a source and a drain of the address transistor 23. The other one of the source and the drain of the address transistor 23 is connected to the vertical signal line 27. A gate of the address transistor 23 is connected to the address signal line 36.

In the example illustrated in FIG. 2, the power supply wire 31 is a source follower power supply. The amplification transistor 21 and the load circuit 119 illustrated in FIG. 1 form a source follower circuit. The amplification transistor 21 outputs a pixel signal according to an amount of signal charge accumulated in the charge accumulation unit Z. Specifically, the amplification transistor 21 outputs a pixel signal according to a potential of the charge accumulation unit Z that has fluctuated due to accumulation of a signal charge in the charge accumulation unit Z after the potential of the charge accumulation unit Z is reset by the reset transistor 22. The pixel signal is selectively read out by the address transistor 23. The pixel signal is specifically a signal voltage.

The reset transistor 22 resets the potential of the charge accumulation unit Z. Specifically, when the reset transistor 22 is turned on, the reset voltage VRST is applied from the reset voltage line 33 to the charge accumulation unit Z via the reset transistor 22. This resets the potential of the charge accumulation unit Z. During exposure, the reset transistor 22 is OFF.

In the present embodiment, each of the amplification transistor 21, the reset transistor 22, and the address transistor 23 is a metal oxide semiconductor field-effect transistor (MOSFET) and is specifically an N-channel MOSFET. The following describes an example in which each of the amplification transistor 21, the reset transistor 22, and the address transistor 23 is an N-channel MOSFET. Note that each of these transistors may be a P-channel MOSFET. Not all of these transistors need be N-channel MOSFETs and not all of these transistors need be P-channel MOSFETs.

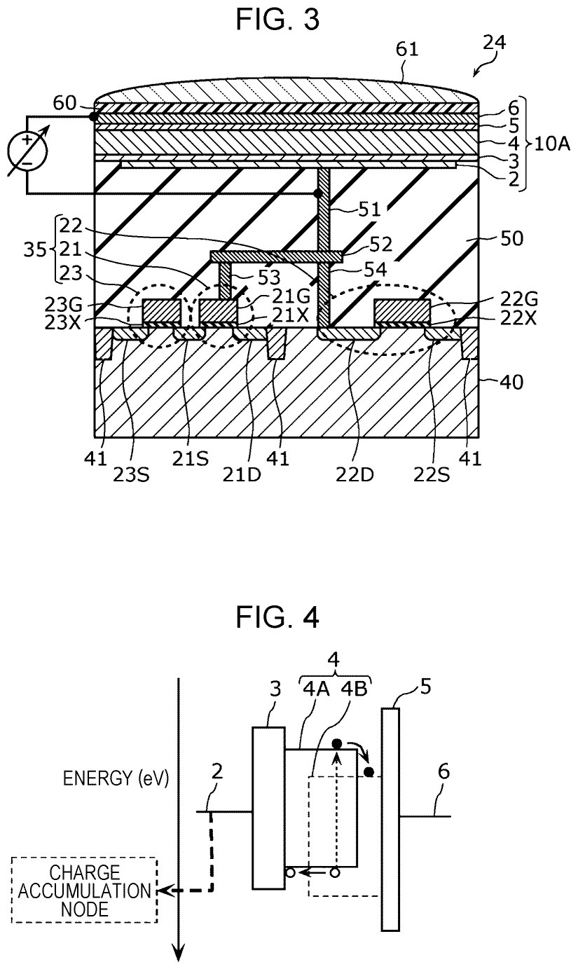

Next, a device structure of the pixel 24 is described. FIG. 3 is a schematic cross-sectional view illustrating an example of a device structure of the pixel 24 according to the present embodiment.

As illustrated in FIG. 3, the pixel 24 includes a semiconductor substrate 40, a signal detection circuit 35, and the photoelectric conversion unit 10A.

The semiconductor substrate 40 may be an insulating substrate or the like on which a semiconductor layer is provided on a surface on a side where a photosensitive region is formed and is, for example, a p-type silicon substrate. The semiconductor substrate 40 has impurity regions 21D, 21S, 22D, 22S, and 23S and an element separation region 41 for electric separation between the pixels 24. The impurity regions 21D, 21S, 22D, 22S, and 23S are, for example, n-type regions. In this example, the element separation region 41 is provided between the impurity region 21D and the impurity region 22D. This suppresses leakage of a signal charge accumulated in the charge accumulation unit Z. Note that the element separation region 41 is, for example, formed by ion implantation of an acceptor under a predetermined implantation condition.

The impurity regions 21D, 21S, 22D, 22S, and 23S are, for example, diffusion regions formed in the semiconductor substrate 40. As illustrated in FIG. 3, the amplification transistor 21 includes the impurity region 21S, the impurity region 21D, and a gate electrode 21G. The impurity region 21S and the impurity region 21D function, for example, as a source region and a drain region of the amplification transistor 21, respectively. A channel region of the amplification transistor 21 is provided between the impurity region 21S and the impurity region 21D.

Similarly, the address transistor 23 includes the impurity region 23S and the impurity region 21S, and a gate electrode 23G connected to the address signal line 36. In this example, the amplification transistor 21 and the address transistor 23 share the impurity region 21S and are thus electrically connected to each other. The impurity region 23S functions, for example, as a source region of the address transistor 23. The impurity region 23S has connection with the vertical signal line 27 illustrated in FIG. 2.

The reset transistor 22 includes the impurity regions 22D and 22S and a gate electrode 22G connected to the reset signal line 37 illustrated in FIG. 2. The impurity region 22S functions, for example, as a source region of the reset transistor 22. The impurity region 22S has connection with the reset signal line 37 illustrated in FIG. 2.

On the semiconductor substrate 40, an interlayer insulating layer 50 is laminated so as to cover the amplification transistor 21, the address transistor 23, and the reset transistor 22.

A wiring layer (not illustrated) can be disposed in the interlayer insulating layer 50. The wiring layer is, for example, made of a metal such as copper and can include, for example, a wire such as the vertical signal line 27 as a part thereof. The number of insulating layers in the interlayer insulating layer 50 and the number of layers included in the wiring layer disposed in the interlayer insulating layer 50 can be freely set.

In the interlayer insulating layer 50, a contact plug 53 connected to the impurity region 22D of the reset transistor 22, a contact plug 51 connected to the pixel electrode 2, and a wire 52 that connects the contact plug 51, a contact plug 54, the contact plug 53. The impurity region 22D of the reset transistor 22 is thus electrically connected to the gate electrode 21G of the amplification transistor 21.

The signal detection circuit 35 detects a signal charge collected by the pixel electrode 2 and outputs a signal voltage. The signal detection circuit 35 includes the amplification transistor 21, the reset transistor 22, and the address transistor 23, and is provided on the semiconductor substrate 40.

The amplification transistor 21 includes the impurity region 21D and the impurity region 21S provided in the semiconductor substrate 40 and functioning as a drain electrode and a source electrode, respectively, a gate insulating layer 21X provided on the semiconductor substrate 40, and the gate electrode 21G provided on the gate insulating layer 21X.

The reset transistor 22 includes the impurity region 22D and the impurity region 22S provided in the semiconductor substrate 40 and functioning as a drain electrode and a source electrode, respectively, a gate insulating layer 22X provided on the semiconductor substrate 40, and the gate electrode 22G provided on the gate insulating layer 22X.

The address transistor 23 includes the impurity regions 21S and 23S provided in the semiconductor substrate 40 and functioning as a drain electrode and a source electrode, respectively, a gate insulating layer 23X provided on the semiconductor substrate 40, and the gate electrode 23G provided on the gate insulating layer 23X. By the impurity region 21S, the amplification transistor 21 and the address transistor 23 are connected in series.

The photoelectric conversion unit 10A is disposed on the interlayer insulating layer 50. In other words, in the present embodiment, the plurality of pixels 24 that constitute the pixel array 501 are provided on the semiconductor substrate 40. The plurality of pixels 24 two-dimensionally arranged on the semiconductor substrate 40 form a photosensitive region. A distance (i.e., a pixel pitch) between two connected pixels 24 may ne, for example, approximately 2 μm.

The photoelectric conversion unit 10A includes the pixel electrode 2, the counter electrode 6 opposed to the pixel electrode 2, the photoelectric conversion layer 4 located between the counter electrode 6 and the pixel electrode 2, a charge blocking layer 3 located between the pixel electrode 2 and the photoelectric conversion layer 4, and a charge blocking layer 5 located between the photoelectric conversion layer 4 and the counter electrode 6. The charge blocking layer 3, the photoelectric conversion layer 4, the charge blocking layer 5, and the counter electrode 6 are, for example, common to the plurality of pixels 24.

In the photoelectric conversion unit 10A, the counter electrode 6, the charge blocking layer 5, the photoelectric conversion layer 4, the charge blocking layer 3, and the pixel electrode 2 are disposed in this order from a side where light is incident on the imaging device 101. In the present embodiment, the side where light is incident on the imaging device 101 is a side opposite to the semiconductor substrate 40 of the photoelectric conversion unit 10A.

The pixel electrode 2 is made of a metal, a metal nitride, a metal oxide, polysilicon given electric conductivity, or the like. Examples of the metal include aluminum, copper, titanium, and tungsten. A method for giving electric conductivity to polysilicon is, for example, doping with an impurity. The pixel electrode 2 is provided for each of the plurality of pixels 24.

The counter electrode 6 is, for example, a transparent electrode made of a transparent conductive material. Examples of a material for the counter electrode 6 include transparent conducting oxide (TCO), indium tin oxide (ITO), indium zinc oxide (IZO), aluminum-doped zinc oxide (AZO), fluorine-doped tin oxide (FTO), SnO₂, and TiO₂. Note that the counter electrode 6 may be made of a metal material such as TCO, aluminum (Al), or gold (Au) alone or may be made of these metal materials in combination as appropriate depending on desired transmittance.

Note that materials for the pixel electrode 2 and the counter electrode 6 are not limited to the above conductive materials, and may be other materials.

Various methods can be used to produce the pixel electrode 2 and the counter electrode 6 depending on a material used. For example, in a case where ITO is used, a chemical reaction method such as an electron beam method, a sputtering method, a resistance heating vapor deposition method, or a sol-gel method, application of an indium tin oxide dispersion, or the like may be used. In this case, UV-ozone treatment, plasma treatment, or the like may be further performed after formation of an ITO film to produce the pixel electrode 2 and the counter electrode 6.

The photoelectric conversion layer 4 contains a donor semiconductor material and an acceptor semiconductor material. The photoelectric conversion layer 4 is, for example, produced by using an organic semiconductor material. A method for producing the photoelectric conversion layer 4 can be, for example, a wet method such as an application method such as spin coating or a dry method such as a vacuum deposition method. The vacuum deposition method is a method of evaporating a layer material by heating under vacuum and depositing the material on a substrate.

The photoelectric conversion layer 4 is, for example, a mixture film having a bulk-hetero structure containing a donor organic semiconductor material and an acceptor organic semiconductor material. The photoelectric conversion layer 4 may be a multi-layer film containing a donor organic semiconductor material and an acceptor organic semiconductor material. Specific examples of the donor organic semiconductor material and the acceptor organic semiconductor material are described below.

Examples of the donor organic semiconductor material include a triaryl amine compound, a benzidine compound, a pyrazoline compound, a styryl amine compound, a hydrazone compound, a triphenylmethane compound, a carbazole compound, a polysilane compound, a thiophene compound, a phthalocyanine compound, a naphthalocyanine compound, a subphthalocyanine compound, a cyanine compound, a merocyanine compound, an oxonol compound, a polyamine compound, an indole compound, a pyrrole compound, a pyrazole compound, a biphenyl compound, a terphenyl compound, a polyarylene compound, a condensed aromatic carbocyclic compound, and a metal complex having a nitrogen-containing hetero ring compound as a ligand.

Examples of the condensed aromatic carbocyclic compound include a naphthalene derivative, an anthracene derivative, a phenanthrene derivative, a tetracene derivative, a pyrene derivative, a perylene derivative, and a fluoranthene derivative.

Examples of the acceptor organic semiconductor material include fullerene, a fullerene derivative, a condensed aromatic carbocyclic compound, 5- or 7-membered hetero ring compound containing a nitrogen atom, an oxygen atom, and a sulfur atom, a polyarylene compound, a fluorene compound, a cyclopentadiene compound, a silyl compound, and a metal complex having a nitrogen-containing hetero ring compound as a ligand.

The fullerene is, for example, C60 fullerene, C70 fullerene, or the like.

The fullerene derivative is, for example, phenyl-C₆₁-butyric acid methyl ester (PCBM), indene-C₆₀ bisadduct (ICBA), or the like.

The 5- or 7-membered hetero ring compound containing a nitrogen atom, an oxygen atom, and a sulfur atom is, for example, pyridine, pyrazine, pyrimidine, pyridazine, triazine, quinoline, quinoxaline, quinazoline, phthalazine, cinnoline, isoquinoline, pteridine, acridine, phenazine, phenanthroline, tetrazole, pyrazole, imidazole, thiazole, oxazole, indazole, benzimidazole, benzotriazole, benzoxazole, benzothiazole, carbazole, purine, triazolopyridazine, triazolopyrimidine, tetrazaindene, oxadiazole, imidazopyridine, pyrrolidine, pyrrolopyridine, thiadiazolopyridine, dibenzazepine, and tribenzazepine.

Note that the donor organic semiconductor material and the acceptor organic semiconductor material are not limited to the above examples. A low-molecular compound and a polymer compound may be used as the donor organic semiconductor material and the acceptor organic semiconductor material that constitute the photoelectric conversion layer 4 as long as these compounds are organic compounds that can be formed as a photoelectric conversion layer by a dry or wet method.

The photoelectric conversion layer 4 may contain a semiconductor material other than an organic semiconductor material as the donor organic semiconductor material and the acceptor organic semiconductor material. The photoelectric conversion layer 4 may contain, as a semiconductor material, a silicon semiconductor, a compound semiconductor, a quantum dot, a perovskite material, a carbon nanotube, or the like or a mixture of two or more of these materials.

The charge blocking layer 3 is, for example, in contact with the pixel electrode 2 and the photoelectric conversion layer 4. The charge blocking layer 5 is, for example, in contact with the counter electrode 6 and the photoelectric conversion layer 4.

The charge blocking layer 3 contains a second charge blocking material. The charge blocking layer 5 contains a first charge blocking material. As a material used for the charge blocking layer 3 and the charge blocking layer 5, a semiconductor material or an insulating material having an energy band that will be described later is used. The charge blocking layer 3 and the charge blocking layer 5 are, for example, made of an organic semiconductor material. The organic semiconductor material is, for example, the donor organic semiconductor material described above. A material of which the charge blocking layer 3 and the charge blocking layer 5 are made is not limited to the organic semiconductor material, and may be an oxide semiconductor, a nitride semiconductor, an insulator, or the like, or a combination thereof.

The charge blocking layer 5 may contain the same material as the charge blocking layer 3. The charge blocking layer 5 may contain the same material as the donor semiconductor material contained in the photoelectric conversion layer 4.

FIG. 4 is an exemplary energy band diagram in the photoelectric conversion unit 10A illustrated in FIG. 3. In FIG. 4, an energy band of each layer is indicated by a rectangle. In FIG. 4, an electron is indicated by a black circle, a hole is indicated by a white circle, and a part of movement of an electron and a hole is schematically illustrated.

The photoelectric conversion layer 4 generates an exciton therein upon receipt of light irradiation. The generated exciton diffuses in the photoelectric conversion layer 4 and is separated into an electron and a hole at an interface between the acceptor organic semiconductor material and the donor organic semiconductor material. The electron and hole thus separated move toward the pixel electrode 2 or the counter electrode 6 in accordance with an electric field applied to the photoelectric conversion layer 4. In a case where the voltage VITO is applied to the counter electrode 6 so that the potential of the counter electrode 6 becomes higher than the potential of the pixel electrode 2, the electron moves toward the counter electrode 6, and the hole moves toward the pixel electrode 2. In this case, the hole is collected by the pixel electrode 2, and is accumulated as a signal charge in the charge accumulation unit Z electrically connected to the pixel electrode 2. The photoelectric conversion layer 4 thus converts light into a signal charge, and the pixel electrode 2 collects the signal charge generated in the photoelectric conversion layer 4. The counter electrode 6 collects a charge of a polarity opposite to the signal charge. The signal charge collected by the pixel electrode 2 is accumulated in the charge accumulation unit Z. In the present embodiment, a hole is used as the signal charge, and therefore a potential of the charge accumulation unit Z rises as the signal charge is accumulated in the charge accumulation unit Z.

Hereinafter, a material that gives an electron of a pair of electron and hole generated by absorbing light to another material is referred to as a donor material, and a material that receives the electron is referred to as an acceptor material. In the present embodiment, the donor semiconductor material is a donor material, and the acceptor semiconductor material is an acceptor material. In a case where two different kinds of organic semiconductor materials are used, which organic semiconductor material becomes a donor material and which organic semiconductor material becomes an acceptor material are typically decided on the basis of a relative position of energy levels of highest-occupied-molecular-orbital (HOMO) and lowest-unoccupied-molecular-orbital (LUMO) of the two kinds of organic semiconductor materials at a contact interface. An upper end and a lower end of the rectangle indicative of the energy band in FIG. 4 are the energy level of the LUMO and the energy level of the HOMO, respectively. An energy difference between a vacuum level and the energy level of the LUMO is referred to as electron affinity. An energy difference between the vacuum level and the energy level of the HOMO is referred to as ionization potential. In FIG. 4, a lower position indicates larger electron affinity and larger ionization potential.

As illustrated in FIG. 4, of the two kinds of semiconductor materials contained in the photoelectric conversion layer 4, one that is shallow in energy level of the LUMO, that is, smaller in electron affinity is a donor semiconductor material 4A, which is a donor material. Of the two kinds of semiconductor materials contained in the photoelectric conversion layer 4, one that is deep in energy level of the LUMO, that is, larger in electron affinity is an acceptor semiconductor material 4B, which is an acceptor material. Note that although the energy band of the donor semiconductor material 4A and the energy band of the acceptor semiconductor material 4B are shifted laterally in FIG. 4, this is merely for better visualization and does not mean that the donor semiconductor material 4A and the acceptor semiconductor material 4B are distributed in the thickness direction of the photoelectric conversion layer 4. Although the energy band of the acceptor semiconductor material 4B is indicated by the broken-line rectangle, this is also for better visualization and does not intend distinguishment from the solid-line rectangle.

The ionization potential of the donor semiconductor material 4A is, for example, smaller than the ionization potential of the acceptor semiconductor material 4B.

In FIG. 4, electron affinity and ionization potential of the charge blocking layer 3 are, for example, electron affinity and ionization potential of the second charge blocking material contained in the charge blocking layer 3. Electron affinity and ionization potential of the charge blocking layer 5 are, for example, electron affinity and ionization potential of the first charge blocking material contained in the charge blocking layer 5.

The charge blocking layer 3 is configured to block a charge of a polarity opposite to the signal charge. The electron affinity of the charge blocking layer 3 is, for example, equal to or less than the electron affinity of the acceptor semiconductor material 4B of the photoelectric conversion layer 4. The charge blocking layer 3 suppresses injection of a charge (specifically, an electron) of a polarity opposite to the signal charge from the pixel electrode 2 to the photoelectric conversion layer 4. This can reduce a noise signal caused by a dark current that gives adverse influence on an S/N ratio.

The charge blocking layer 5 is configured to block a charge of a polarity opposite to the signal charge. The electron affinity of the charge blocking layer 5 is smaller than the electron affinity of the acceptor semiconductor material 4B. The electron affinity of the charge blocking layer 5 may be smaller than the electron affinity of the acceptor semiconductor material 4B by 1 eV or more.

Since the charge blocking layer 5 having electron affinity smaller than the electron affinity of the acceptor semiconductor material 4B is provided, an electron generated in the photoelectric conversion layer 4 can be accumulated on an interface between the photoelectric conversion layer 4 and the charge blocking layer 5. In particular, in a case where the electron affinity of the charge blocking layer 5 is smaller than the electron affinity of the acceptor semiconductor material 4B by 1 eV or more, an electron generated in the photoelectric conversion layer 4 is easily accumulated on the interface between the photoelectric conversion layer 4 and the charge blocking layer 5.

The ionization potential of the charge blocking layer 5 is, for example, equal to or larger than the ionization potential of the donor semiconductor material 4A. The charge blocking layer 5 thus suppresses injection of a signal charge (specifically, a hole) from the counter electrode 6 to the photoelectric conversion layer 4. This can reduce a noise signal that gives adverse influence on an S/N ratio.

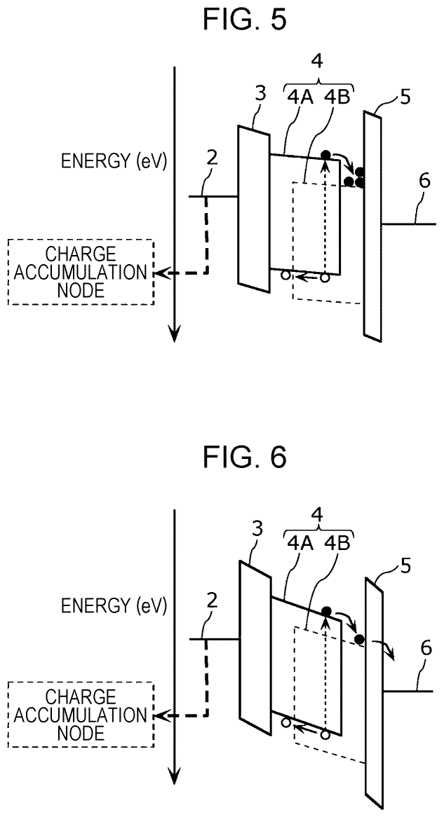

FIG. 5 illustrates energy bands in a case where a low voltage VITO is applied to the counter electrode 6 so that the potential of the counter electrode 6 becomes higher than the potential of the pixel electrode 2 in the photoelectric conversion unit 10A having the energy band configuration illustrated in FIG. 4. In FIG. 5, an electron is indicated by a black circle, a hole is indicated by a white circle, and a part of movement of an electron and a hole is schematically illustrated, as in FIG. 4. Hereinafter, a potential difference between the counter electrode 6 and the pixel electrode 2 is sometimes referred to as a “bias voltage”.

As illustrated in FIG. 5, an electron generated in the photoelectric conversion layer 4 is accumulated on the interface between the photoelectric conversion layer 4 and the charge blocking layer 5. The accumulated electron becomes a space charge in the photoelectric conversion layer 4 and mitigates an electric field. Furthermore, the electron accumulated on the interface between the photoelectric conversion layer 4 and the charge blocking layer 5 can be re-coupled with a hole. Due to an effect of the electric field mitigation and re-coupling, an amount of signal charge taken out to the pixel electrode 2 is very small, and is less likely to change even when the bias voltage changes.

FIG. 6 illustrates energy bands in a case where a voltage VITO higher than that in the case illustrated in FIG. 5 is applied to the counter electrode 6 so that the potential of the counter electrode 6 becomes higher than the potential of the pixel electrode 2 in the photoelectric conversion unit 10A having the energy band configuration illustrated in FIG. 4. In a case where an electric field intensity in the charge blocking layer 5 is sufficiently high, the electron accumulated on the interface between the photoelectric conversion layer 4 and the charge blocking layer 5 has energy enough to pass through the charge blocking layer 5 and is taken out to the counter electrode 6. This reduces the effect of the electric field mitigation, thereby increasing an amount of signal charge taken out to the pixel electrode 2.

As described above, the state illustrated in FIG. 5 is obtained in a voltage range in which a bias voltage that causes the electron accumulated on the interface between the photoelectric conversion layer 4 and the charge blocking layer 5 to have energy enough to pass through the charge blocking layer 5 is applied, and therefore the photoelectric conversion unit 10A can keep photoelectric conversion efficiency low in a wide voltage range.

See FIG. 3 again. A color filter 60 is provided above the photoelectric conversion unit 10A, and a microlens 61 is provided above the color filter 60. The color filter 60 is, for example, formed as an on-chip color filter by patterning by using a material such as a photo-sensitive resin in which dye or pigment is dispersed. The microlens 61 is, for example, formed as an on-chip microlens by using a material such as an ultraviolet-sensitive material.

A typical semiconductor production process can be used to produce the imaging device 101. In particular, in a case where a silicon substrate is used as the semiconductor substrate 40, the imaging device 101 can be produced by using various silicon semiconductor processes.

The imaging device 101 may operate according to a rolling shutter system in which the plurality of pixels 24 are sequentially exposed to light, for example, per pixel row and signals are read out or may operate according to a global shutter system in which exposure periods of the plurality of pixels 24 are uniform. In a case where the imaging device 101 operates according to the rolling shutter system, the voltage supply circuit 126, for example, keeps supplying a voltage that causes sensitivity in the photoelectric conversion unit 10A to the counter electrode 6 during imaging, and signal charge readout operation is sequentially performed per pixel row. In a case where the imaging device 101 operates according to the global shutter system, the voltage supply circuit 126, for example, supplies, to the counter electrode 6, a voltage that causes sensitivity in the photoelectric conversion unit 10A during an exposure period and supplies, to the counter electrode 6, a voltage that does not cause sensitivity in the photoelectric conversion unit 10A in a non-exposure period. During this non-exposure period, signal charge readout operation is sequentially performed per pixel row. Note that the readout operation of the imaging device 101 is not limited to such operation, and known readout operation of an imaging device can be applied.

### Exemplary Photoelectric Conversion Characteristics of Photoelectric Conversion Unit

Photoelectric conversion characteristics of the photoelectric conversion unit 10A are described below. Specifically, a relationship between photoelectric conversion efficiency of the photoelectric conversion unit 10A and a potential difference (bias voltage) between the pixel electrode 2 and the counter electrode 6 is described.

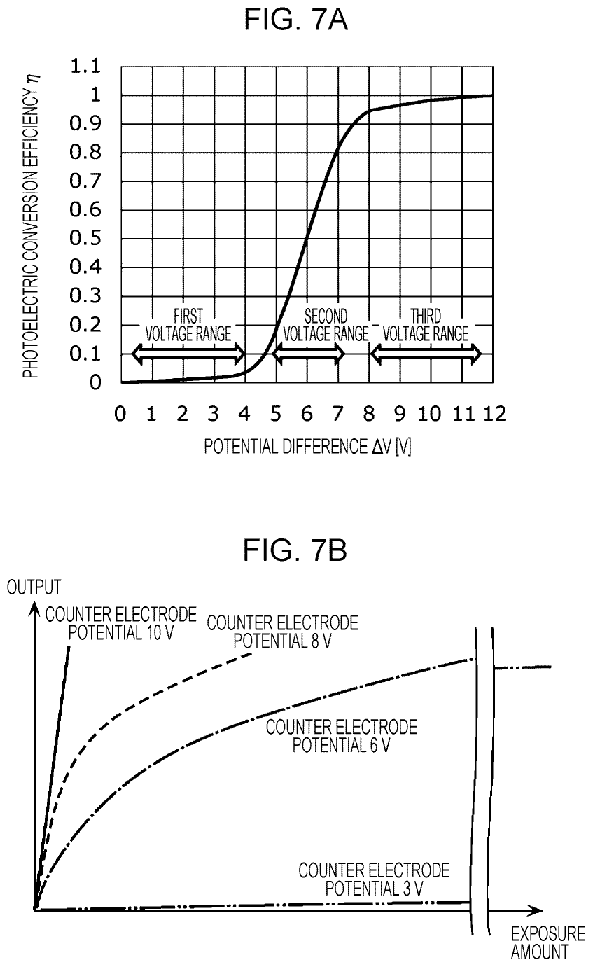

FIG. 7A illustrates an example of schematic photoelectric conversion characteristics of the photoelectric conversion unit 10A. In FIG. 7A, the horizontal axis represents a potential difference ΔV between the counter electrode 6 and the pixel electrode 2, and the vertical axis represents photoelectric conversion efficiency η of the photoelectric conversion unit 10A. The photoelectric conversion efficiency η means a ratio of the number of charges collected by the pixel electrode 2 per unit second to the number of photons absorbed by the photoelectric conversion unit 10A regarding a single pixel 24. Note that the number of charges is a number measured while using an elementary charge as a unit. The photoelectric conversion efficiency η is, for example, measured under irradiation of light of 1000 lux, and may be measured, for example, under irradiation of light of 300 lux or more in a case where standard indoor illuminance is considered.

The photoelectric conversion efficiency η is indicated by any standardized unit, and a value obtained when the photoelectric conversion efficiency η does not substantially change when the potential difference ΔV is increased is 1. Note that in the present specification, the value obtained when the photoelectric conversion efficiency η does not substantially change when the potential difference ΔV is increased is, for example, a value obtained when a change of the photoelectric conversion efficiency η is 1% or less in a case where the potential difference ΔV is increased not to break the photoelectric conversion unit 10A and is changed by 1 V.

The potential difference ΔV illustrated in FIG. 7A is one in a case where the potential of the counter electrode 6 is higher than the potential of the pixel electrode 2. The photoelectric conversion characteristics illustrated in FIG. 7A are photoelectric conversion characteristics in a reverse bias region where a bias voltage in a reverse direction is applied. In a case where the photoelectric conversion layer 4 has a bulk-hetero structure, a forward direction and a reverse direction of a bias voltage are defined between the photoelectric conversion layer 4 and an electrode that is in contact with the photoelectric conversion layer 4. Specifically, a level whose energy difference from a Fermi level of an electrode material that constitutes the electrode is smallest is selected from among the HOMO and LUMO levels of the organic materials contained in the photoelectric conversion layer 4. A bias voltage applied to the electrode so that it becomes easy for an electron or a hole to be injected into the selected level is a forward direction, and a bias voltage applied to the electrode so that it becomes hard for an electron or a hole to be injected into the selected level is a reverse voltage. In a case where the photoelectric conversion layer 4 has a junction structure of a p-type semiconductor layer and an n-type semiconductor layer, a bias voltage that makes a potential of the p-type semiconductor layer higher than a potential of the n-type semiconductor layer is defined as a bias voltage in a forward direction. On the other hand, a bias voltage that makes the potential of the p-type semiconductor layer lower than the potential of the n-type semiconductor layer is defined as a bias voltage in a reverse direction.

As illustrated in FIG. 7A, the photoelectric conversion characteristics of the photoelectric conversion unit 10A according to the present embodiment are schematically characterized by a first voltage range, a second voltage range, and a third voltage range. That is, the photoelectric conversion unit 10A has photoelectric conversion characteristics in which the first voltage range, the second voltage range, and the third voltage range are present.

As illustrated in FIG. 7A, the first voltage range is a voltage range immediately before rising of the photoelectric conversion efficiency η. In the first voltage range, the photoelectric conversion efficiency η is larger than 0, and photoelectric conversion substantially occurs, and a signal charge is collected by the pixel electrode 2. The third voltage range is a voltage range in which the photoelectric conversion efficiency η is saturated. The second voltage range is a voltage range between the first voltage range and the third voltage range. The second voltage range is a voltage range in which the photoelectric conversion efficiency η increases at a larger slope than in the first voltage range and the third voltage range as the potential difference ΔV increases.

The photoelectric conversion characteristics of the photoelectric conversion unit 10A have, for example, a first inflection point and a second inflection point of a voltage higher than a voltage of the first inflection point. For example, the first voltage range is a voltage range present between 0 V and the voltage of the first inflection point in the graph of the photoelectric conversion characteristics. The second voltage range is a voltage range present between the voltage of the first inflection point and the voltage of the second inflection point in the graph of the photoelectric conversion characteristics. The third voltage range is a voltage range larger than the voltage of the second inflection point. The first inflection point is an inflection point that occurs since the photoelectric conversion efficiency η rapidly changes when the potential difference ΔV is increased from 0 V. The voltage of the first inflection point is, for example, a voltage that takes a local maximum value by twice differentiation in the graph of the photoelectric conversion characteristics. The second inflection point is an inflection point that occurs since the photoelectric conversion efficiency η that rapidly changed becomes saturated when the potential difference ΔV is increased from the voltage of the first inflection point. The voltage of the second inflection point is, for example, a voltage that takes a local minimum value by twice differentiation in the graph of the photoelectric conversion characteristics.

The first voltage range corresponds, for example, to the potential difference ΔV that creates the state illustrated in FIG. 5. In a case where the potential difference ΔV is in the first voltage range, electric field mitigation and re-coupling occur due to a charge (electron) accumulated on the interface between the photoelectric conversion layer 4 and the charge blocking layer 5 inside the photoelectric conversion unit 10A, as described with reference to FIG. 5, and therefore the photoelectric conversion efficiency η is low. Due to the electric field mitigation and re-coupling, the signal charge collected by the pixel electrode 2 does not rapidly increase even if the potential difference ΔV increases, and therefore the slope which the photoelectric conversion efficiency η exhibits as the potential difference ΔV increases is small. Since the accumulated charge is a charge of a polarity opposite to the signal charge, the signal charge is partially collected by the pixel electrode 2, and the signal charge is accumulated in the charge accumulation unit Z.

On the other hand, the second voltage range and the third voltage range correspond, for example, to the potential difference ΔV that creates the state illustrated in FIG. 6. In a case where the potential difference ΔV is in the second voltage range, the charge accumulated on the interface between the photoelectric conversion layer 4 and the charge blocking layer 5 passes through the charge blocking layer 5 inside the photoelectric conversion unit 10A, as described with reference to FIG. 6, and therefore the photoelectric conversion efficiency η is high. Furthermore, the increase of the potential difference ΔV leads directly to an increase of energy by which the accumulated charge passes through the charge blocking layer 5, and the slope which the photoelectric conversion efficiency η exhibits as the potential difference ΔV increases is large.

In the third voltage range, the energy by which the accumulated change passes through the charge blocking layer 5 is sufficiently large, and therefore the photoelectric conversion efficiency η is decided by an amount of signal charge generated by photoelectric conversion of the photoelectric conversion layer 4. Accordingly, the photoelectric conversion efficiency η hardly changes even when the potential difference ΔV changes.

Since the charge blocking layer 5 is present in the photoelectric conversion unit 10A, the first voltage range can be widened, and the width of the first voltage range is, for example, 0.5 V or more. The width of the first voltage range may be 1 V or more or may be 2 V or more. Furthermore, the width of the first voltage range may be 5 V or less or may be 4 V or less. Note that the width of the first voltage range may be less than 0.5 V.

In the photoelectric conversion characteristics of the photoelectric conversion unit 10A, for example, a maximum value of the photoelectric conversion efficiency η in the first voltage range is equal to or less than 10% of a maximum value of the photoelectric conversion efficiency η in the second voltage range. For example, the maximum value of the photoelectric conversion efficiency η in the first voltage range is equal to or more than 1% of the maximum value of the photoelectric conversion efficiency η in the second voltage range.

In the photoelectric conversion characteristics of the photoelectric conversion unit 10A, for example, the maximum value of the photoelectric conversion efficiency η in the first voltage range is equal to or less than 10% of a maximum value of the photoelectric conversion efficiency η in the third voltage range. For example, the maximum value of the photoelectric conversion efficiency η in the first voltage range is equal to or more than 1% of the maximum value of the photoelectric conversion efficiency η in the third voltage range.

In the photoelectric conversion characteristics of the photoelectric conversion unit 10A, for example, an amount of change of the photoelectric conversion efficiency η per 0.5 V in the first voltage range is equal to or less than 3% of the maximum value of the photoelectric conversion efficiency η in the third voltage range. For example, the amount of change of the photoelectric conversion efficiency η per 0.5 V in the first voltage range is equal to or more than 0.1% of the maximum value of the photoelectric conversion efficiency η in the third voltage range.

In the photoelectric conversion characteristics of the photoelectric conversion unit 10A, for example, the slope which the photoelectric conversion efficiency η exhibits as the potential difference ΔV increases in the first voltage range is equal to or less than 20% of the slope which the photoelectric conversion efficiency η exhibits as the potential difference ΔV increases in the second voltage range. For example, the slope which the photoelectric conversion efficiency η exhibits as the potential difference ΔV increases in the first voltage range is equal to or more than 1% of the slope which the photoelectric conversion efficiency η exhibits as the potential difference ΔV increases in the second voltage range.

FIG. 7B schematically illustrates a relationship between a pixel signal output and an exposure amount in the pixel 24 including the photoelectric conversion unit 10A having the photoelectric conversion characteristics illustrated in FIG. 7A. The exposure amount is an amount of light incident on the photoelectric conversion unit 10A. Hereinafter, the relationship between a pixel signal output and an exposure amount is sometimes referred to as “exposure amount-pixel signal output characteristics”.

Since a hole is accumulated in the charge accumulation unit Z according to an exposure amount and the potential of the charge accumulation unit Z rises, the potential difference ΔV of the photoelectric conversion unit 10A decreases as the exposure amount increases. For example, assume that the potential of the charge accumulation unit Z immediately after resetting is 1 V and a saturation potential of the charge accumulation unit Z is 3 V, the relationship between a pixel signal output and an exposure amount markedly changes depending on the potential of the counter electrode 6. In the present embodiment, the potential of the charge accumulation unit Z immediately after resetting is the reset voltage VRST, and the potential of the counter electrode 6 is the voltage VITO. In a case where the potential of the counter electrode 6 is 10 V, the potential difference ΔV of the photoelectric conversion unit 10A immediately after resetting is 9 V, and the potential difference ΔV of the photoelectric conversion unit 10A is 7 V when the charge accumulation unit Z is saturated, and the photoelectric conversion efficiency η does not change much, as illustrated in FIG. 7A. On the other hand, in a case where the potential of the counter electrode 6 is 8 V, the potential difference ΔV of the photoelectric conversion unit 10A immediately after resetting is 7 V, and the potential difference ΔV of the photoelectric conversion unit 10A is 5 V when the charge accumulation unit is saturated, and the photoelectric conversion efficiency η markedly changes, as illustrated in FIG. 7A. That is, as illustrated in FIG. 7B, linearity of the pixel signal output with respect to the exposure amount changes depending on the potential of the counter electrode 6, that is, the voltage VITO applied to the counter electrode 6.

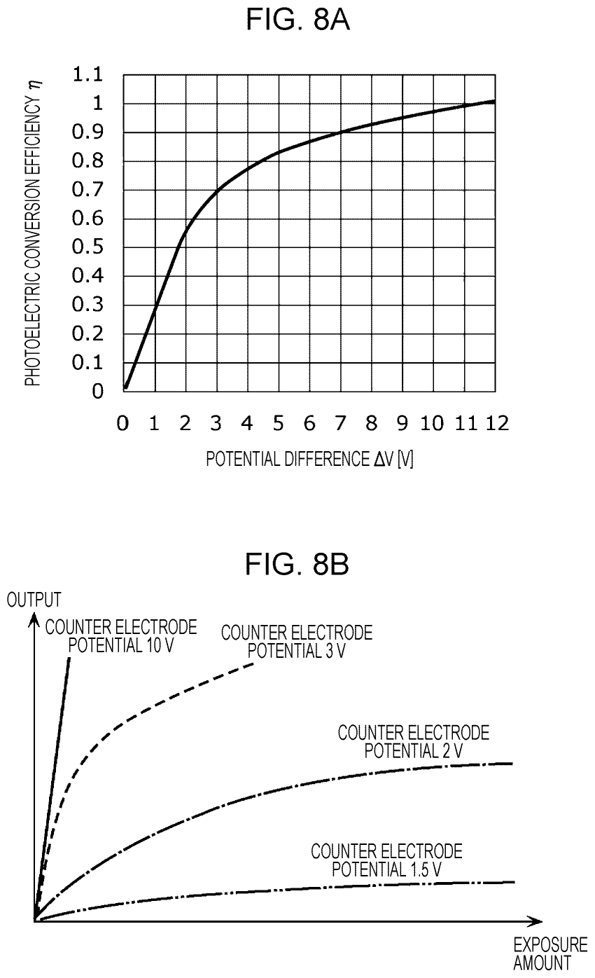

The following describes a case where the photoelectric conversion unit 10A has photoelectric conversion characteristics illustrated in FIG. 7A. Note that the photoelectric conversion characteristics of the photoelectric conversion unit 10A according to the present embodiment are not limited to the example illustrated in FIG. 7A. FIG. 8A illustrates another example of schematic photoelectric conversion characteristics of the photoelectric conversion unit 10A. FIG. 8A illustrates an example of photoelectric conversion characteristics, for example, in a case where the photoelectric conversion unit 10A does not include the charge blocking layer 5. The vertical axis and the horizontal axis of FIG. 8A are identical to those of FIG. 7A.

In the example illustrated in FIG. 8A, there is no electric field mitigation effect described above produced by a charge accumulated on the interface between the photoelectric conversion layer 4 and the charge blocking layer 5, and the photoelectric conversion efficiency η rapidly increases from around 0 V. Therefore, in the example illustrated in FIG. 8A, the first voltage range does not substantially exist.

FIG. 8B schematically illustrates a relationship between a pixel signal output and an exposure amount in the pixel 24 including the photoelectric conversion unit 10A having the photoelectric conversion characteristics illustrated in FIG. 8A. Even in a case where the photoelectric conversion unit 10A has the photoelectric conversion characteristics illustrated in FIG. 8A, linearity of the pixel signal output with respect to the exposure amount changes depending on the potential of the counter electrode 6, that is, the voltage VITO applied to the counter electrode 6, as illustrated in FIG. 8B.

In the photoelectric conversion characteristics illustrated in FIG. 8A, the potential difference ΔV at which the slope of the photoelectric conversion efficiency η becomes large as the potential difference ΔV increases is small, as compared with the photoelectric conversion characteristics illustrated in FIG. 7A. Accordingly, in the case of the pixel 24 including the photoelectric conversion unit 10A having the photoelectric conversion characteristics illustrated in FIG. 8A, the potential of the counter electrode 6 at which the photoelectric conversion efficiency η is markedly changed with respect to the potential difference ΔV is small assuming 10 V as a standard as the potential of the counter electrode 6. Furthermore, the saturation potential of the charge accumulation unit Z does not rise beyond the potential of the counter electrode 6, and therefore a maximum amplitude of the pixel signal output is limited by the potential of the counter electrode 6. Accordingly, for example, as illustrated in FIG. 8B, assume that the potential of the charge accumulation unit Z immediately after resetting is 1 V and the saturation potential of the charge accumulation unit Z is 3 V, the pixel signal output does not rise to the maximum amplitude (saturation potential) when the potential of the counter electrode 6 is 2 V or 1.5 V.

### Operation of Imaging Device

Next, operation of the imaging device 101 is described as an imaging method of the imaging device 101. Specifically, the following describes signal processing of a pixel signal output from the pixel 24, and others.

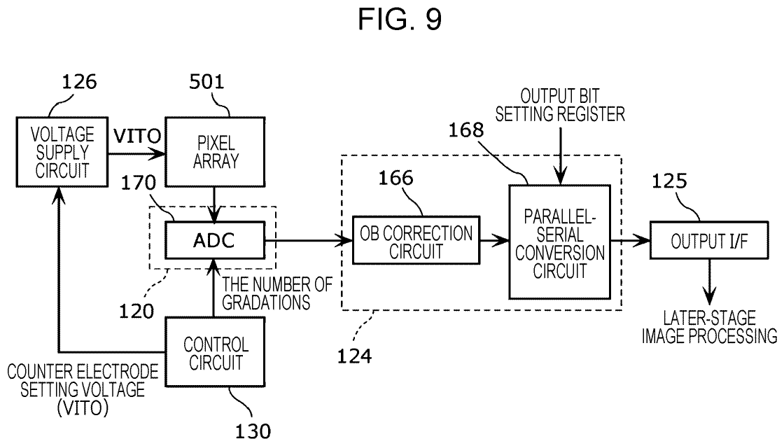

FIG. 9 is a block diagram illustrating signal processing of the imaging device according to the present embodiment. The signal processing is described below with reference to FIG. 9. Note that constituent elements necessary for description of the signal processing are illustrated in FIG. 9 to facilitate understanding, and not all constituent elements of the imaging device 101 are illustrated in FIG. 9.

The voltage supply circuit 126 supplies the voltage VITO set on the basis of control of the control circuit 130 to the counter electrode 6 of each pixel 24 included in the pixel array 501. In the pixel array 501, exposure and readout of the pixel 24 are performed, and an analog pixel signal of a level according to an exposure amount of the pixel 24 is output from the pixel 24. The exposure amount-pixel signal output characteristics can have linearity depending on the voltage VITO applied to the counter electrode 6, as illustrated, for example, in FIG. 7B. In this case, the reset voltage VRST is fixed at a predetermined voltage.

The pixel signal output from the pixel 24 is converted into a first signal, which is a digital signal including pixel data, by an AD conversion circuit 170 included in the column signal processing circuit 120. That is, the AD conversion circuit 170 performs AD conversion of the pixel signal. In this process, the AD conversion circuit 170 performs AD conversion of the pixel signal by the number of gradations of digital output set by the control circuit 130. The control circuit 130 changes the number of gradations of digital output of the AD conversion in accordance with the voltage VITO. In the present specification, the number of gradations of digital output of the AD conversion of the pixel signal performed by the AD conversion circuit 170 is sometimes simply referred to as “the number of gradations of AD conversion”. The first signal is output to the digital processing unit 124. The number of gradations of the AD conversion is also referred to as a “quantization unit of AD conversion”.

The imaging device 101 includes, for example, an optical black (OB) pixel (not illustrated), for example, at an end portion of the pixel array 501. An OB correction circuit 166 included in the digital processing unit 124 receives the first signal and performs OB correction of the first signal by using the OB pixel. In the OB correction, a difference between the first signal and a signal output from the OB pixel is calculated. By performing OB correction on the first signal of each of the plurality of pixels 24, black levels of the first signals are made uniform. Note that the imaging device 101 need not perform the OB correction.

Next, the first signal that has been subjected to the OB correction is output to a parallel-serial conversion circuit 168 included in the digital processing unit 124. The parallel-serial conversion circuit 168 converts a digital signal in a parallel state into a serial signal. In the parallel-serial conversion circuit 168, the number of bits of serial data per pixel data into which the signal is converted is decided on the basis of an output bit setting register. The number of output bits (the number of gradations) decided by the output bit setting register is, for example, set on the basis of control of the control circuit 130. The control circuit 130 sets the number of output bits, for example, in accordance with the voltage VITO or the number of gradations of the AD conversion.

The serial pixel data obtained by the conversion in the parallel-serial conversion circuit 168 is output by the output I/F 125 such as low voltage differential signaling (LVDS) or scalable low voltage signaling (SLVS).

Details of each signal processing is described below.

First, the AD conversion of the pixel signal and correction of the signal after the AD conversion are described.

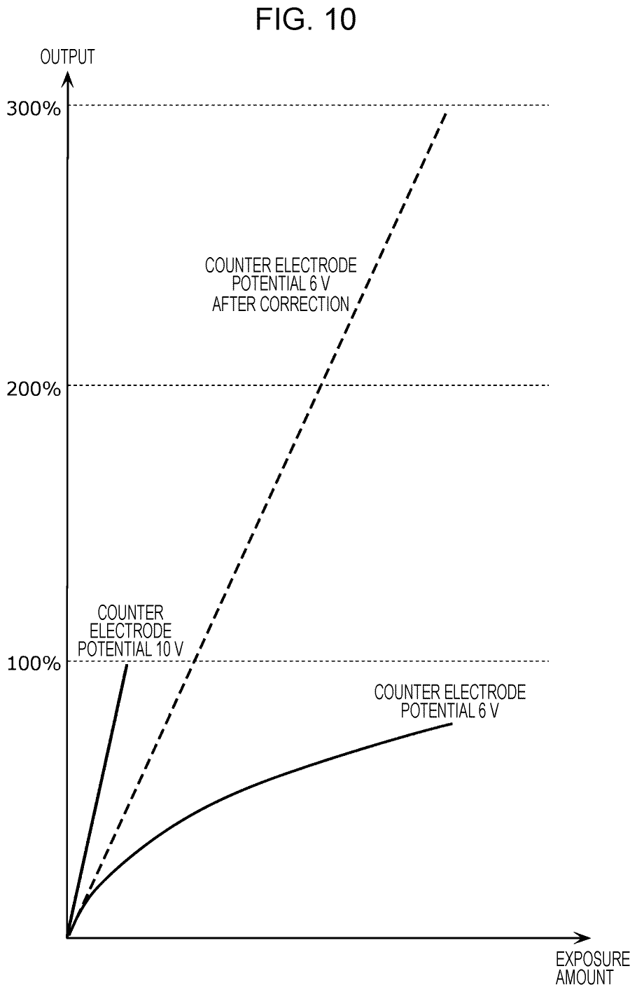

FIG. 10 schematically illustrates an example of a change of an output level of the pixel signal with respect to a change of an amount of light incident on the photoelectric conversion unit 10A (exposure amount). As illustrated in FIG. 10, in a case where the potential of the counter electrode 6 is 10 V, the level of the pixel signal exhibits a linear change with respect to a change of the exposure amount, and linearity is high. On the other hand, in a case where the potential of the counter electrode 6 is 6 V, a degree of increase of the level of the pixel signal with respect to an increase of the exposure amount becomes duller as the exposure amount becomes larger, and a graph showing a change of the signal level with respect to a change of the exposure amount exhibits a curved change. Since an increase of the signal level automatically decreases as the exposure amount increases, a dynamic range on a high illuminance side is enlarged. As a result, the dynamic range on a high illuminance side can be enlarged approximately three times larger than that in a case where the signal level linearly changes as the exposure amount increases. For example, as illustrated in FIG. 10, the output is increased by correcting the exposure amount-pixel signal output characteristics into a linear shape.

In FIG. 10, the case where the potential of the counter electrode 6 is 10 V is a case where the voltage supply circuit 126 supplies the voltage VITO to the counter electrode 6 so that the potential difference ΔV is in the third voltage range. The case where the potential of the counter electrode 6 is 6 V is a case where the voltage supply circuit 126 supplies the voltage VITO to the counter electrode 6 so that the potential difference ΔV is in the second voltage range. In the present embodiment, the first voltage range is present in the photoelectric conversion characteristics of the photoelectric conversion unit 10A, and therefore the voltage VITO that makes the potential difference ΔV fall in the second voltage range can be set higher than that in a case where the first voltage range is not present.

By obtaining an exposure amount-pixel signal output characteristics curve such as the one illustrated in FIG. 10 in advance, a level of the pixel signal detected by the signal detection circuit 35 can be subjected to appropriate correction.

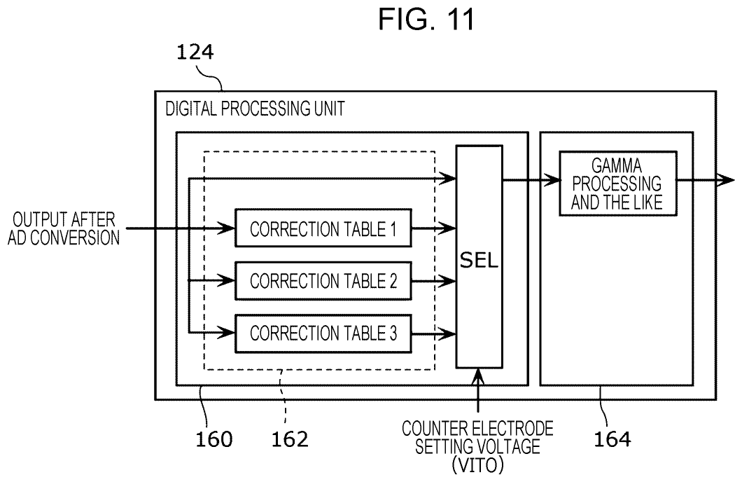

FIG. 11 is a block diagram schematically illustrating an outline of linearity compensation processing.

As illustrated in FIG. 11, the digital processing unit 124 includes, for example, a correction circuit 160 and an image processing circuit 164. The image processing circuit 164 performs, for example, processing such as gamma processing, OB processing, and parallel-serial conversion processing. The image processing circuit 164 may include the OB correction circuit 166 and the parallel-serial conversion circuit 168. The correction circuit 160 may include, for example, a memory 162 in which correction coefficients according to light amounts are stored in advance, for example, in the form of a table, and may decide, as pixel values of the pixels 24, pixel values multiplied by the correction coefficients. By the linearity compensation processing of performing such correction, the linearity can be compensated, and the dynamic range on a high illuminance side can be further enlarged.

For example, a table for converting a digital value of the first signal may be prepared for each voltage value of the voltage VITO that can be output from the voltage supply circuit 126.

In the example illustrated in FIG. 11, three correction tables 1 to 3 corresponding to the voltages VITO that can be output from the voltage supply circuit 126 are held in the memory 162. For example, the correction circuit 160 receives, for example, the first signal that is an output after the analog-digital conversion and applies a correction table in accordance with a specific value of the voltage VITO applied from the voltage supply circuit 126 to the photoelectric conversion unit 10A. Note that the linearity compensation processing may be performed in a stage later than the output I/F 125 instead of the digital processing unit 124.

The output after the correction is delivered to the image processing circuit 164 and is, for example, subjected to processing such as gamma processing, OB processing, and parallel-serial conversion processing.

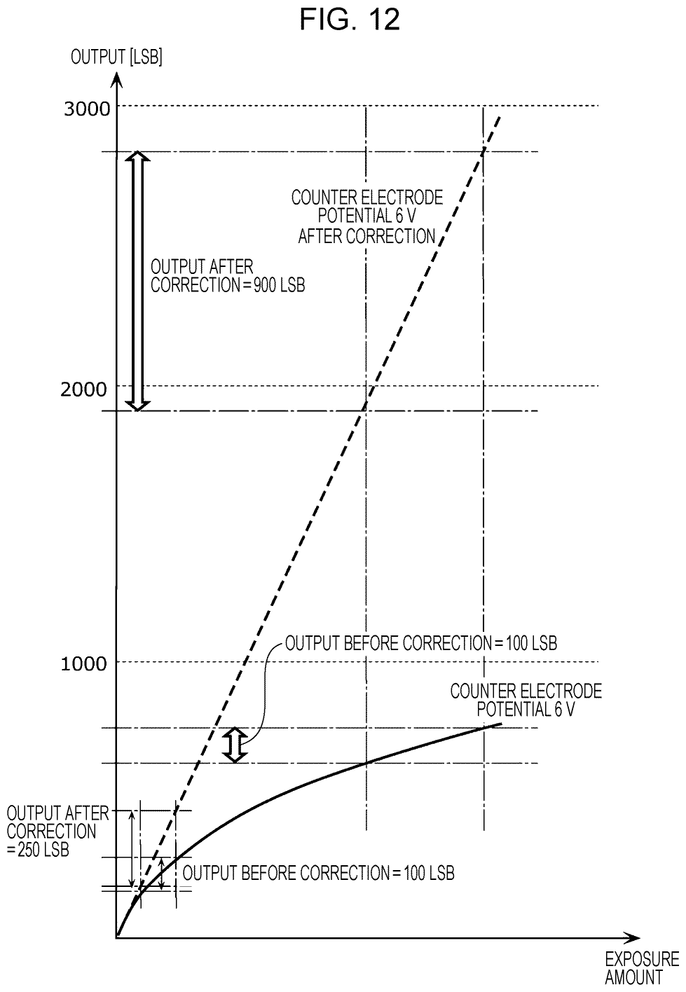

FIG. 12 schematically illustrates output values before and after the linearity compensation processing in a case where the potential of the counter electrode 6 is 6 V. As illustrated in FIG. 12, in a region where the exposure amount is small (low illuminance side), output before the correction is 100 LSB, whereas output after the correction is 250 LSB. On the other hand, in a region where the exposure amount is large (high illuminance side), output before the correction is 100 LSB, whereas output after the correction is 900 LSB. That is, weight of 1 LSB before the correction is larger in the region where the exposure amount is large. Accordingly, influence of quantization noise is also large. This is because linearity of a magnitude of the pixel signal with respect to the exposure amount is low and therefore a slope of an increase of the output with respect to an increase of the exposure amount before the correction is small in the region where the exposure amount is large.

In the imaging device 101 according to the present embodiment, the quantization unit is reduced, that is, the number of gradations of the AD conversion is increased to reduce the quantization noise. On the other hand, when the number of gradations of the AD conversion is increased, a longer time is needed for the AD conversion. This invites a decrease in frame rate, an increase in electric power consumption, and the like. Therefore, the number of gradations of the AD conversion is adaptively controlled depending on whether or not linearity correction is needed.

For example, in a case where the potential of the counter electrode 6 is 10 V, linearity is high, and therefore linearity correction is not needed. Accordingly, the number of gradations of the AD conversion is not increased. On the other hand, in a case where the potential of the counter electrode 6 is 6 V, control for increasing the number of gradations of the AD conversion is performed.

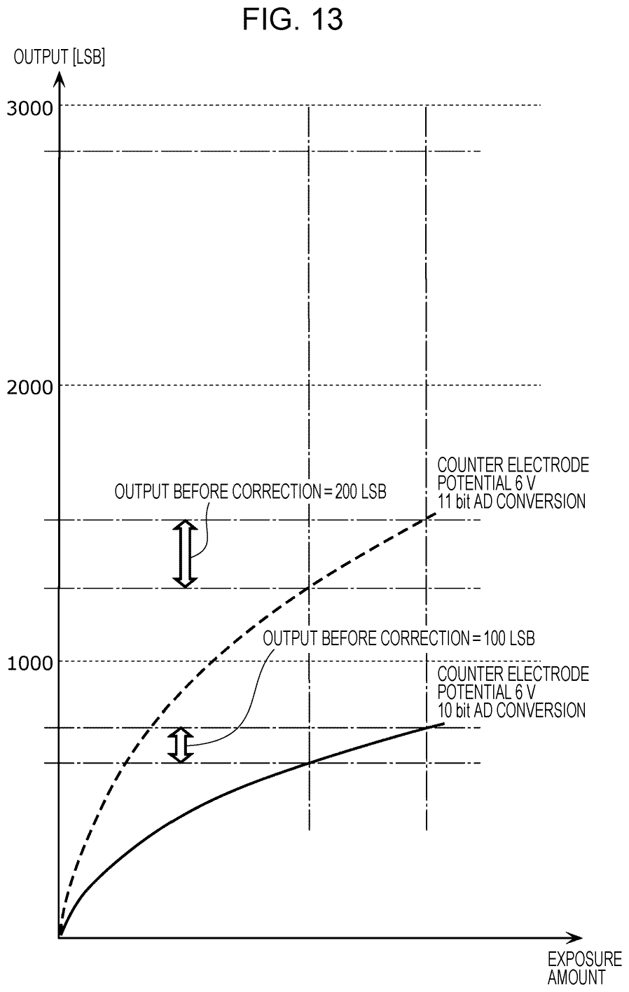

FIG. 13 schematically illustrates an output value obtained by 10-bit AD conversion and an output value obtained by 11-bit AD conversion in a case where the potential of the counter electrode 6 is 6 V. As illustrated in FIG. 13, the output value obtained by the 11-bit AD conversion is two times larger than the output value obtained by the 10-bit AD conversion. That is, in a case where linearity correction is performed to the same straight line both in the case of the 10-bit AD conversion and the case of the 11-bit AD conversion, weight of 1 LSB before the linearity correction is smaller and influence of the quantization noise is smaller in the case of the 11-bit AD conversion.

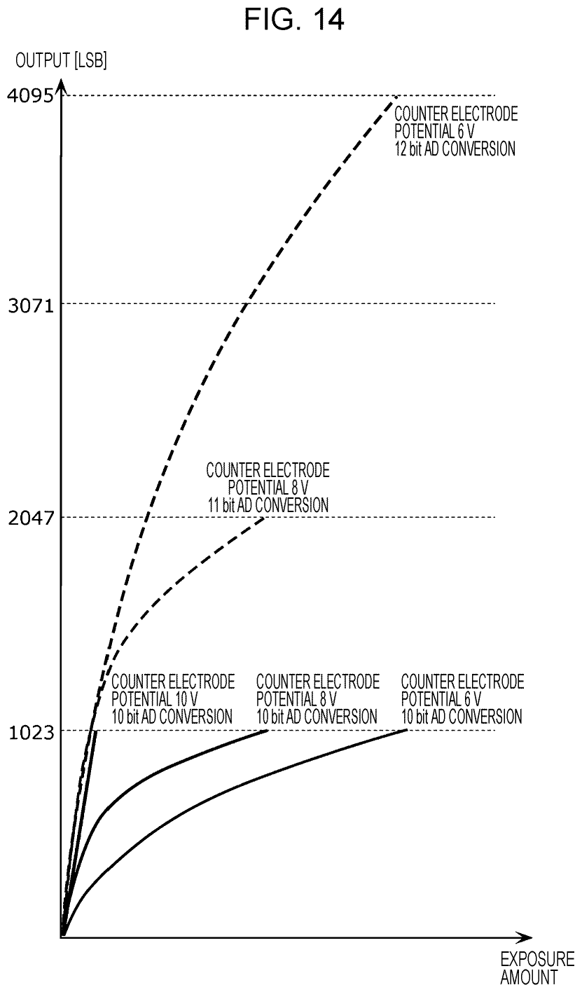

FIG. 14 schematically illustrates output values in cases where the potential of the counter electrode 6 is 6 V, 8 V, and 10 V. In a case where the potential of the counter electrode 6 is 10 V, linearity is high, and a slope of an increase of the output with respect to an increase of the exposure amount is large, and therefore an AD conversion mode (the number of gradations of the AD conversion) is 10 bits. This can suppress an increase in electric power consumption. On the other hand, as the potential of the counter electrode 6 becomes lower, the linearity decreases, and a slope of an increase of the output with respect to an increase of the exposure amount on a high illuminance side before correction becomes smaller. Accordingly, the AD conversion circuit 170 performs 11-bit AD conversion in a case where the potential of the counter electrode 6 is 8 V, and performs 12-bit AD conversion in a case where the potential of the counter electrode 6 is 6 V. In this way, the control circuit 130 performs control of switching to the number of gradations of the AD conversion suitable for linearity in accordance with the potential of the counter electrode 6, that is, the voltage VITO applied to the counter electrode 6.

Specifically, in a case where linearity of a magnitude of a pixel signal with respect to an exposure amount is low, a region where a slope of an increase of the output with respect to an increase of the exposure amount is large and a region where the slope is small are present. The control circuit 130 sets, for example, the number of gradations of AD conversion according to a smallest slope in characteristics of an output signal with respect to an exposure amount that is decided in accordance with the voltage VITO applied to the counter electrode 6. For example, the control circuit 130 sets the number of gradations of the AD conversion so that the number of gradations of the AD conversion becomes larger as the smallest slope becomes smaller. Furthermore, for example, the control circuit 130 sets the number of gradations of the AD conversion in a case where the voltage VITO that makes the potential difference ΔV fall in the second voltage range is supplied to the pixels 24 larger than the number of gradations of the AD conversion in a case where the voltage VITO that makes the potential difference ΔV fall in the third voltage range is supplied to the pixels 24. This can reduce the quantization noise, thereby suppressing degradation of an S/N ratio.

Note that even in a case where the photoelectric conversion unit 10A has the exposure amount-pixel signal output characteristics illustrated in FIG. 8B, linearity of a pixel signal output with respect to an exposure amount changes depending on the voltage VITO. Therefore, by changing the number of gradations of the AD conversion in accordance with the voltage VITO in a similar manner to that described above, a dynamic range can be widened while suppressing degradation of an S/N ratio.

Next, the parallel-serial conversion processing is described.

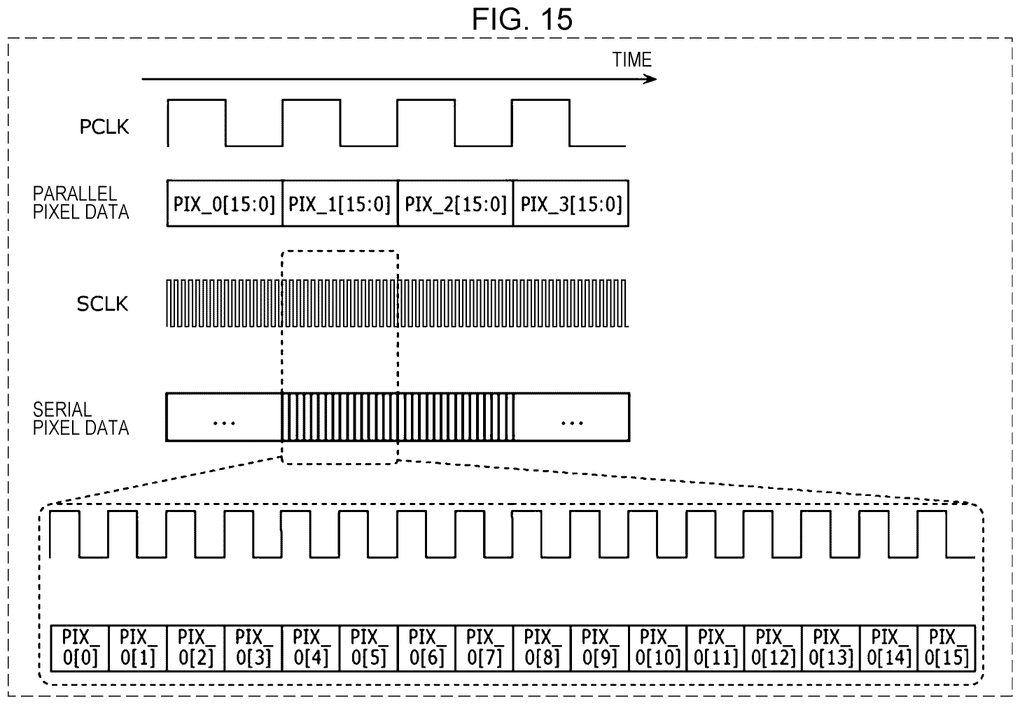

FIG. 15 schematically illustrates operation of converting 16-bit parallel pixel data into serial pixel data in the parallel-serial conversion circuit 168. In the operation illustrated in FIG. 15, the conversion is performed so that the number of bits of the parallel pixel data (i.e., the number of bits of the AD conversion) and the number of output bits of the serial pixel data are identical. Hereinafter, the number of output bits of the serial pixel data is sometimes referred to as “the number of sensor output bits”. As illustrated in FIG. 15, parallel-serial conversion of a single piece of parallel pixel data obtained by 16-bit AD conversion needs such a speed that 16 T of a transfer clock SCLK of serial pixel data corresponds to 1 T of a transfer clock PCLK of the parallel pixel data. 1 T is one cycle of a clock repeating a High level and a Low level and is an interval of rising (or falling) of a clock. Although the serial pixel data is sequentially output from a least significant bit (LSB) in the example illustrated in FIG. 15, the serial pixel data may be sequentially output from a most significant bit (MSB). Furthermore, although pixel data is packed every 16 bits, pixel data may be packed every 8 bits.

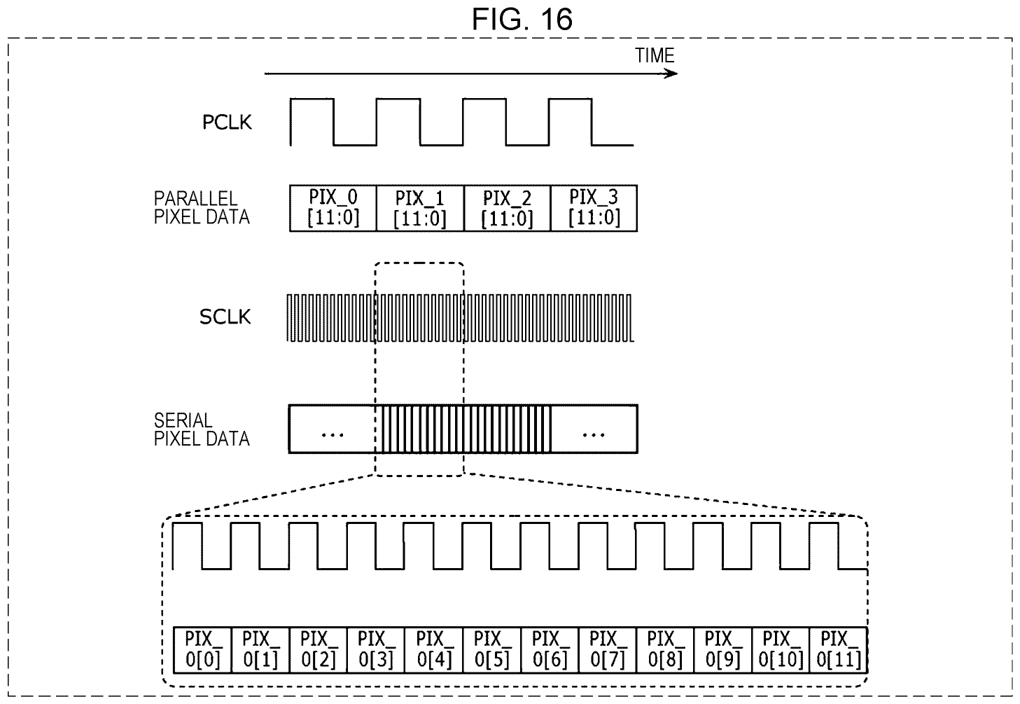

FIG. 16 schematically illustrates operation of converting 12-bit parallel pixel data into serial pixel data in the parallel-serial conversion circuit 168. In the operation illustrated in FIG. 16, the conversion is performed so that the number of bits of the parallel pixel data and the number of output bits of the serial pixel data are identical. As illustrated in FIG. 16, parallel-serial conversion of a single piece of parallel pixel data obtained by 12-bit AD conversion needs such a speed that 12 T of a transfer clock SCLK of serial pixel data corresponds to 1 T of a transfer clock PCLK of the parallel pixel data. In the case illustrated in FIG. 16, a time needed for conversion of a single piece of pixel data is reduced to 12/16 as compared with the case illustrated in FIG. 15, if there is no difference in speed of the transfer clock SCLK of the serial pixel data. Since the number of bits of the AD conversion becomes the number of bits of the parallel pixel data, a time needed for parallel-serial conversion of a single piece of pixel data can be made shorter as the number of bits of the AD conversion is made smaller, if the number of bits of the AD conversion and the number of sensor output bits are identical.

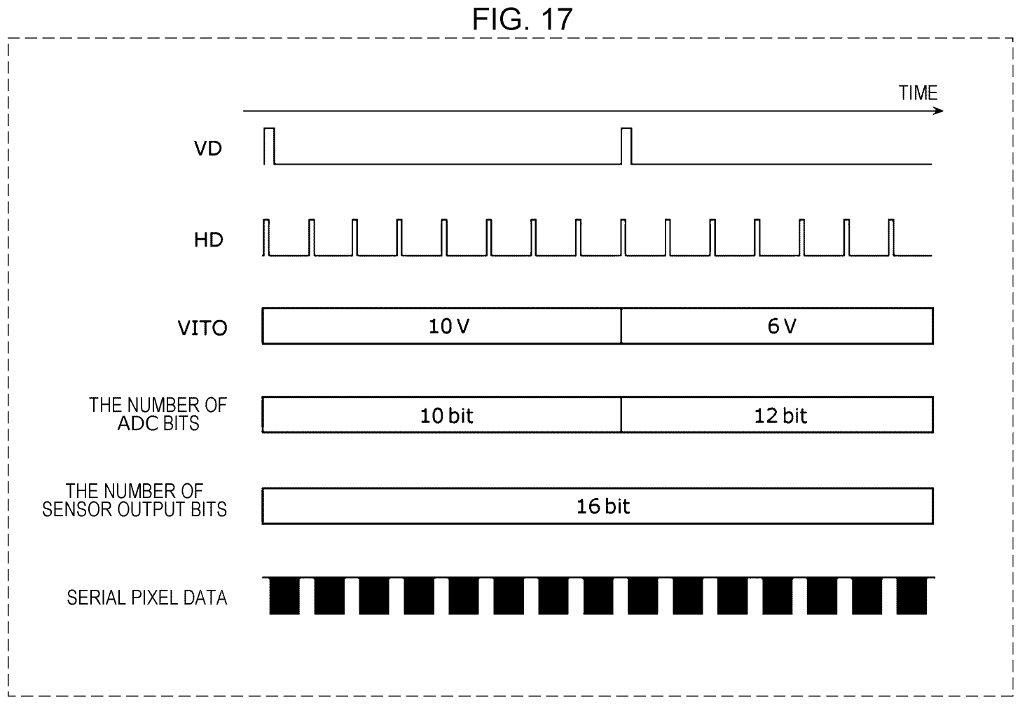

FIG. 17 schematically illustrates an example of operation in a case where the voltage VITO applied to the counter electrode and the number of bits of the AD conversion are changed between frames. In the operation illustrated in FIG. 17, concerning a vertical synchronizing signal VD and a horizontal synchronizing signal HD corresponding to two frames, the voltage VITO supplied to the counter electrode 6 is changed from 10 V to 6 V and the number of bits (the number of ADC bits) of the AD conversion is changed from 10 bits to 12 bits at a time of switching of the frames. In the example illustrated in FIG. 17, a frame rate is constant. As illustrated in FIG. 17, the control circuit 130 changes the number of bits of the AD conversion in accordance with the voltage VITO supplied to the counter electrode 6 at a time of switching of the frames. This can produce an effect of suppressing degradation of an S/N ratio while suppressing an increase in electric power consumption as described above since the number of bits of the AD conversion in the case where the applied voltage VITO is 6 V is larger than that in a case where the applied voltage VITO is 10 V.

In the example illustrated in FIG. 17, the number of sensor output bits is constant at 16 bits irrespective of the number of bits of the input parallel pixel data. In such a case, the serial pixel data is output at the constant number of sensor output bits, and therefore processing for setting the number of sensor output bits is lessened.

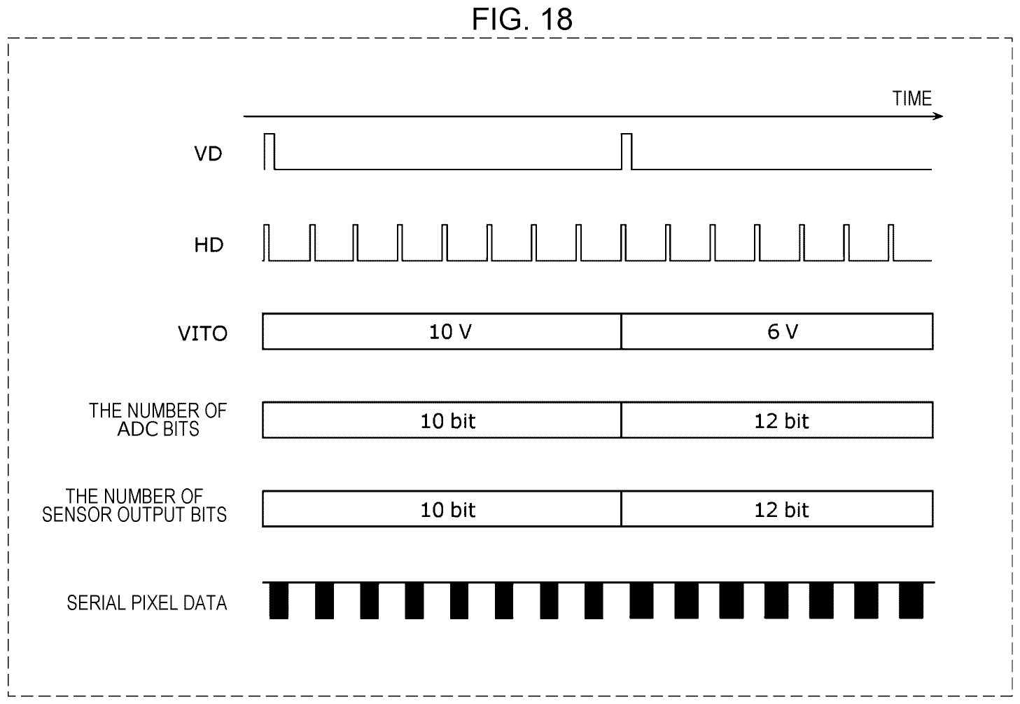

FIG. 18 schematically illustrates an example of operation in a case where the voltage VITO applied to the counter electrode, the number of bits of the AD conversion, and the number of sensor output bits are changed between frames. In the operation illustrated in FIG. 18, concerning a vertical synchronizing signal VD and a horizontal synchronizing signal HD corresponding to two frames, the voltage VITO supplied to the counter electrode 6 is changed from 10 V to 6 V, the number of bits of the AD conversion (the number of ADC bits) is changed from 10 bits to 12 bits, and the number of sensor output bits is changed from 10 bits to 12 bits at a time of switching of the frames. The example illustrated in FIG. 18 is different from the example illustrated in FIG. 17 in that the number of sensor output bits is changed at a time of switching of the frames. In the example illustrated in FIG. 18, the control circuit 130 changes the number of sensor output bits in accordance with the number of bits of the AD conversion at a time of switching of the frames. Specifically, the control circuit 130 sets the number of sensor output bits identical to the number of bits of the AD conversion. As a result, in a case where the number of bits of the AD conversion is reduced, the number of sensor output bits is also reduced. This can reduce output serial pixel data, thereby suppressing an increase in electric power consumption.

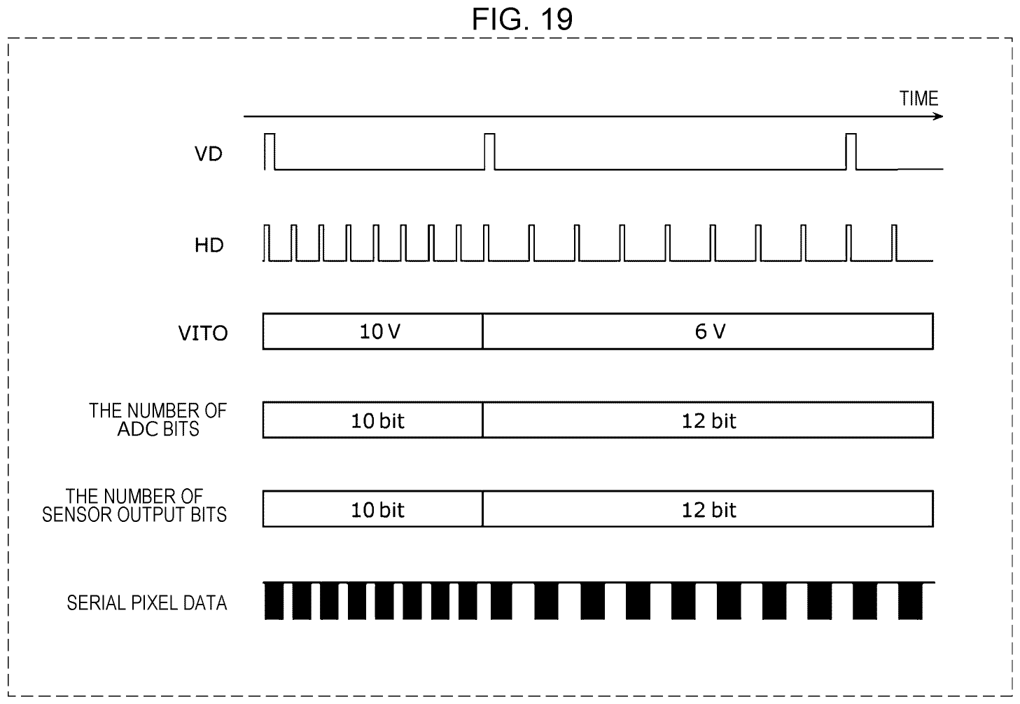

FIG. 19 schematically illustrates an example of operation in a case where the frame rate, the voltage VITO applied to the counter electrode, the number of bits of the AD conversion, and the number of sensor output bits are changed between frames. In the operation illustrated in FIG. 19, concerning a vertical synchronizing signal VD and a horizontal synchronizing signal HD corresponding to two frames, a length of a rising interval (1 HD period) of the horizontal synchronizing signal HD, that is, a frame rate is changed, the voltage VITO supplied to the counter electrode 6 is changed from 10 V to 6 V, the number of bits of the AD conversion (the number of ADC bits) is changed from 10 bits to 12 bits, and the number of sensor output bits is changed from 10 bits to 12 bits at a time of switching of frames. The example illustrated in FIG. 19 is different from the example illustrated in FIG. 18 in that the frame rate is changed at a time of switching of the frames. As described with reference to FIGS. 15 and 16, a time needed for parallel-serial conversion can be made shorter as the number of bits of the AD conversion becomes smaller. Accordingly, in the example illustrated in FIG. 19, the control circuit 130 changes the frame rate in accordance with the number of bits of the AD conversion at a time of switching of the frames. Specifically, the control circuit 130 sets the frame rate higher, that is, sets the rising interval of the horizontal synchronizing signal HD shorter as the number of bits of the AD conversion becomes smaller. As a result, in a case where the number of bits of the AD conversion becomes small, the frame rate is increased, and thereby a decrease in frame rate can be suppressed.

As described above, in the imaging device 101 according to the present embodiment, linearity of a magnitude of a pixel signal with respect to an amount of light incident on the photoelectric conversion unit 10A changes depending on the voltage VITO supplied from the voltage supply circuit 126 to the pixels 24. Furthermore, the control circuit 130 changes the number of gradations of AD conversion performed by the AD conversion circuit 170 in accordance with the voltage VITO.

As described above, in the imaging device 101, linearity of a magnitude of a pixel signal with respect to an amount of light incident on the photoelectric conversion unit 10A changes depending on the voltage VITO. Therefore, in a case where the voltage VITO that lowers the linearity is set, a slope of the magnitude of the pixel signal with respect to the amount of incident light is small on a high illuminance side. Accordingly, in the imaging device 101, a dynamic range on a high illuminance side is enlarged. In a case where such a small slope of the magnitude of the pixel signal is corrected, weight per gradation in the AD conversion is large, and quantization noise increases. However, in the imaging device 101, an output value in the AD conversion can be increased by changing the number of gradations of the AD conversion in accordance with the voltage VITO. As a result, the weight per gradation in the AD conversion is reduced, and in a case where the slope of the magnitude of the pixel signal is corrected, influence of quantization noise is reduced, and degradation of an S/N ratio can be suppressed. Therefore, according to the imaging device 101, a dynamic range can be enlarged while suppressing degradation of an S/N ratio.

### Another Operation Example of Linearity Compensation Processing

Although the correction circuit 160 of the digital processing unit 124 performs correction of a signal after AD conversion in the linearity compensation processing described above, this is not restrictive. For example, a slope of exposure amount-pixel signal output characteristics may be corrected by the AD conversion processing of the AD conversion circuit 170. The following describes a case where the AD conversion circuit 170 includes a comparator that compares a reference voltage signal and a pixel signal and a counter circuit (AD counter).

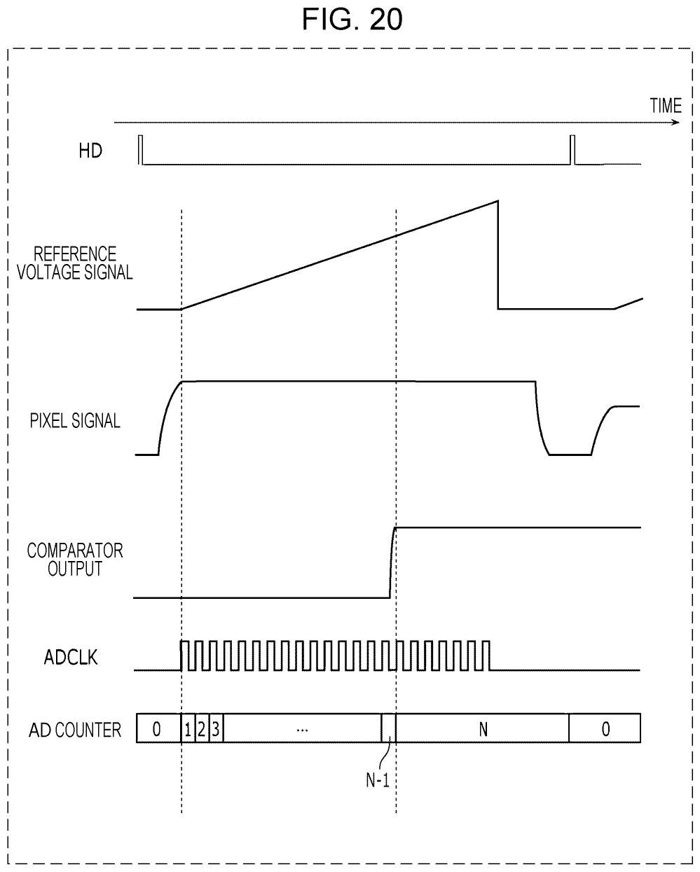

FIG. 20 schematically illustrates an example of operation in a case where AD conversion is performed linearly on a pixel signal voltage. In the operation illustrated in FIG. 20, a slope of exposure amount-pixel signal output characteristics is not corrected by the AD conversion circuit 170. As illustrated in FIG. 20, a pixel signal and a reference voltage signal, which is a linear ramp wave, are input to the comparator, and a clock ADCLK for AD counter is input to the AD counter at the same time as start of input of the reference signal. The linear reference voltage signal in this case is, for example, output from a digital to analog converter (DAC) in which an input clock cycle is constant. Output of the comparator is a Low level in a case where the pixel signal is higher than the reference voltage signal and is a High level in a case where the pixel signal is equal to or lower than the reference voltage signal. In a case where the output of the comparator is a Low level, the AD counter counts up, and in a case where the output of the comparator is a High level, the AD counter stops. An AD counter value at a time of the stoppage is output. In this way, linear AD conversion is performed on an analog pixel signal. In a case where such AD conversion is performed, linearity compensation processing using a correction table such as the one described above is performed.

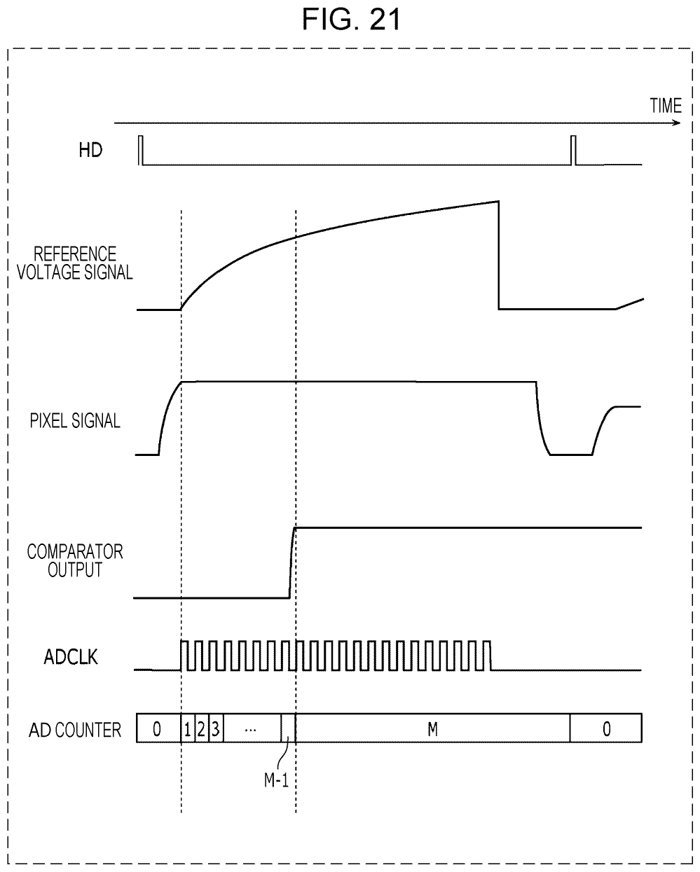

FIG. 21 schematically illustrates an example of operation in a case where AD conversion is performed non-linearly on a pixel signal voltage. In the operation illustrated in FIG. 21, the exposure amount-pixel signal output characteristics are corrected by the AD conversion circuit 170. As illustrated in FIG. 21, a pixel signal and a non-linear reference voltage signal are input to the comparator, and a clock ADCLK for AD counter is input to the AD counter at the same time as start of input of the reference signal. The non-linear reference voltage signal in this case is, for example, output from a DAC in which a cycle of an input clock is modulated. For example, in the DAC, in a case where the cycle of the input clock is fast, a slope of the reference voltage signal is large. In a case where the output of the comparator is a Low level, the AD counter counts up, and in a case where the output of the comparator is a High level, the AD counter stops. An AD counter value at a time of the stoppage is output. In this way, non-linear AD conversion is performed on a pixel signal. When non-linearity of the reference voltage signal and non-linearity of the exposure amount-pixel signal output characteristics of the pixel signal match, exposure amount-output LSB characteristics of the pixel signal after AD conversion are linear characteristics. That is, a digital signal is output from the AD conversion circuit 170 after a slope of the exposure amount-pixel signal output characteristics is corrected.

### Embodiment 2

In Embodiment 1, a configuration in which linearity of exposure amount-pixel signal output characteristics changes depending on a voltage applied to the pixels 24 due to photoelectric conversion characteristics of the photoelectric conversion unit 10A has been described. However, the present disclosure is also applicable to an imaging device having a different configuration. In Embodiment 2, an imaging device having a configuration in which gain changes depending on a potential of a charge accumulation unit Z is described as an example of the imaging device having a different configuration. In the description of Embodiment 2 below, differences from Embodiment 1 are mainly described, and description of common points is omitted or simplified.

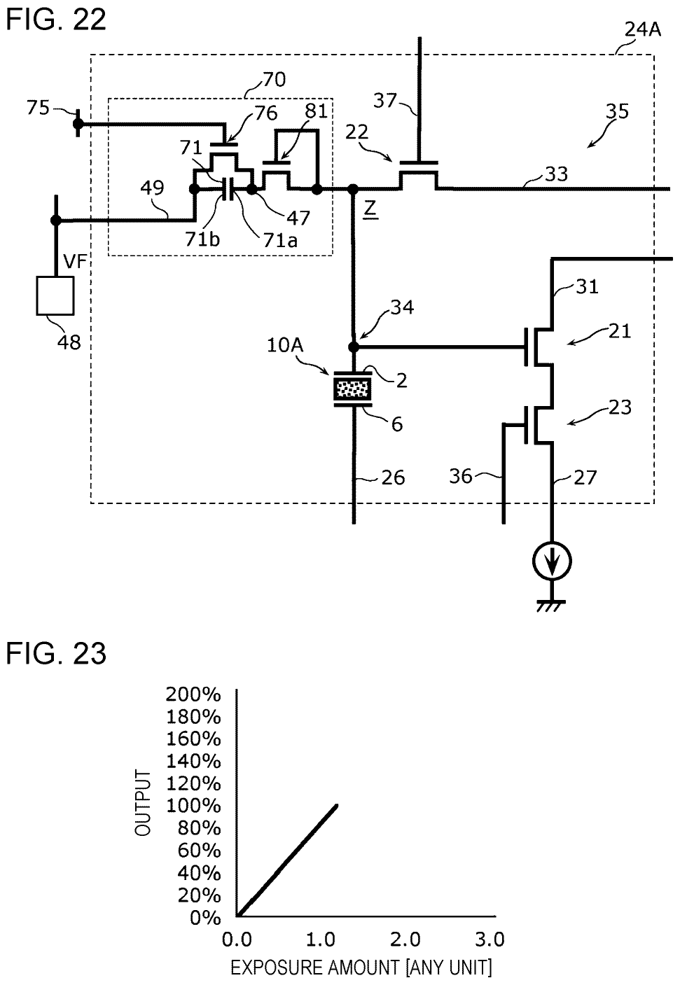

FIG. 22 illustrates an exemplary circuit configuration of a pixel 24A according to the present embodiment.

The imaging device according to the present embodiment is mainly different from the imaging device 101 according to Embodiment 1 in that the imaging device according to the present embodiment includes the pixels 24A instead of the pixels 24 and further includes a voltage supply circuit 48. The voltage supply circuit 48 supplies a control voltage VF to the pixels 24A.

The pixel 24A further includes a capacitance circuit 70 in addition to the configuration of the pixel 24. The capacitance circuit 70 includes a first capacitor 71, a first transistor 81, and a specific reset transistor 76.

In the present embodiment, for example, a voltage supply circuit 126 supplies a voltage VITO of a predetermined value, and a voltage supply circuit 127 supplies a reset voltage VRST of a predetermined value. The voltage VITO and the reset voltage VRST are, for example, set so that a potential difference applied to the photoelectric conversion unit 10A falls within a third voltage range.

The first capacitor 71 includes a first terminal 71a, a second terminal 71b, and a dielectric layer. In the present embodiment, the first capacitor 71 is, for example, a metal insulator metal (MIM) capacitor and/or a metal oxide metal (MOM) capacitor.

Hereinafter, a source of the first transistor 81 is sometimes referred to as a first source. A drain of the first transistor 81 is sometimes referred to as a first drain. A gate of the first transistor 81 is sometimes referred to as a first gate.

In the present embodiment, the first gate is connected to a charge accumulation node 34. One of the first source and the first drain is connected to the charge accumulation node 34. The other one of the first source and the first drain is connected to the first terminal 71a. The second terminal 71b is connected to the voltage supply circuit 48 through a voltage line 49. Accordingly, the first transistor 81 and the first capacitor 71 are connected in series between the voltage line 49 connected to the voltage supply circuit 48 and the charge accumulation unit Z (specifically, the charge accumulation node 34). Specifically, the voltage supply circuit 48, the first capacitor 71, the first transistor 81, and the charge accumulation unit Z are connected in series in this order. The first gate of the first transistor 81 is connected to the charge accumulation unit Z. Accordingly, the first transistor 81 is connected between the first terminal 71a and the charge accumulation unit Z. To the second terminal 71b of the first capacitor 71, the control voltage VF is applied from the voltage supply circuit 48. In the present embodiment, the control voltage VF is an example of a first voltage. The voltage line 49 is an example of a first wire.

The voltage supply circuit 48 is electrically connected to the capacitance circuit 70 of each pixel 24A through the voltage line 49. The voltage supply circuit 48 supplies the control voltage VF to the capacitance circuit 70 of each pixel 24A. More specifically, the voltage supply circuit 48 supplies the control voltage VF set on the basis of control of the control circuit 130 to the voltage line 49. The voltage supply circuit 48 is not limited to a specific power supply circuit, and may be a circuit that generates a predetermined voltage or may be a circuit that converts a voltage supplied from another power supply into a predetermined voltage. The voltage supply circuit 48 may be included in a vertical scanning circuit 116 or may be provided separately from the vertical scanning circuit 116. Note that the imaging device according to the present embodiment need not include the voltage supply circuit 48. For example, the control voltage VF may be supplied to each pixel 24 from an external power supply.

In the present embodiment, a node connected to the other one of the first source and the first drain of the first transistor 81 and the first terminal 71a of the first capacitor 71 is sometimes referred to as a node 47.

One of a source and a drain of the specific reset transistor 76 is connected to the node 47. The other one of the source and the drain of the specific reset transistor 76 is connected to the voltage line 49. A gate of the specific reset transistor 76 is connected to a specific reset signal line 75. The specific reset signal line 75 is, for example, connected to the vertical scanning circuit 116, and ON and OFF of the specific reset transistor 76 can be controlled by controlling a potential of the specific reset signal line 75.

The specific reset transistor 76 resets a potential of the node 47. Specifically, when the specific reset transistor 76 is turned on, the control voltage VF is applied from the voltage line 49 to the node 47 via the specific reset transistor 76. This resets the potential of the node 47. During exposure, the specific reset transistor 76 is in an OFF state.

In the present embodiment, the control voltage VF is a direct-current voltage. The control voltage VF in one period and the control voltage VF in another period may be different. For example, the control voltage VF may vary depending on an operation mode.

The capacitance circuit 70 changes a capacitance value of the charge accumulation unit Z in accordance with the potential of the charge accumulation unit Z. This configuration is suitable for realizing a wide dynamic range.

A voltage between the first gate and the first source of the first transistor 81 changes in accordance with the potential of the charge accumulation unit Z. When the potential of the charge accumulation unit Z changes beyond a first threshold potential, the first transistor 81 turns on. As a result, the first capacitor 71 is electrically connected to the charge accumulation node 34. In this case, the first capacitor 71 functions as a part of the charge accumulation unit Z, and the capacitance value of the charge accumulation unit Z increases. For example, when the potential of the node 47 is reset to the control voltage VF before exposure, a threshold potential of the charge accumulation unit Z at which the first transistor 81 turns on can be controlled by the control voltage VF. That is, the imaging device according to the present embodiment can control linearity of exposure amount-pixel signal output characteristics even by the control voltage VF.

In the present embodiment, the voltage supply circuit 48 may switch an imaging mode by changing the first threshold potential by using the control voltage VF. For example, the mode may be switched to a first mode in which the first transistor 81 is always OFF by setting the first threshold potential high and may be switched to a second mode in which the first transistor 81 is turned on and off in accordance with the potential of the charge accumulation unit Z by setting the first threshold potential relatively low. In this case, the second mode can be a mode of higher saturation and lower sensitivity than the first mode.

In the present embodiment, in the second mode, the first transistor 81 is turned on in accordance with the potential of the charge accumulation unit Z. This increases the capacitance value of the charge accumulation unit Z. On the other hand, in the first mode, the first transistor 81 is always kept OFF. Accordingly, an increase in capacitance value of the charge accumulation unit Z caused by the first capacitor 71 does not occur.

In the second mode, pseudo gamma characteristics can be obtained in the pixel 24A. Therefore, the state where the imaging mode is the second mode can be referred to as “auto gamma ON”. On the other hand, in the first mode, the control voltage VF is set so that the capacitance circuit 70 does not change the capacitance value of the charge accumulation unit Z. Therefore, the state where the imaging mode is the first mode can be referred to as “auto gamma OFF”. In this way, in this example, it is possible to switch auto gamma ON and auto gamma OFF by controlling the control voltage VF.

Signals obtained in the first mode and the second mode are further described below.

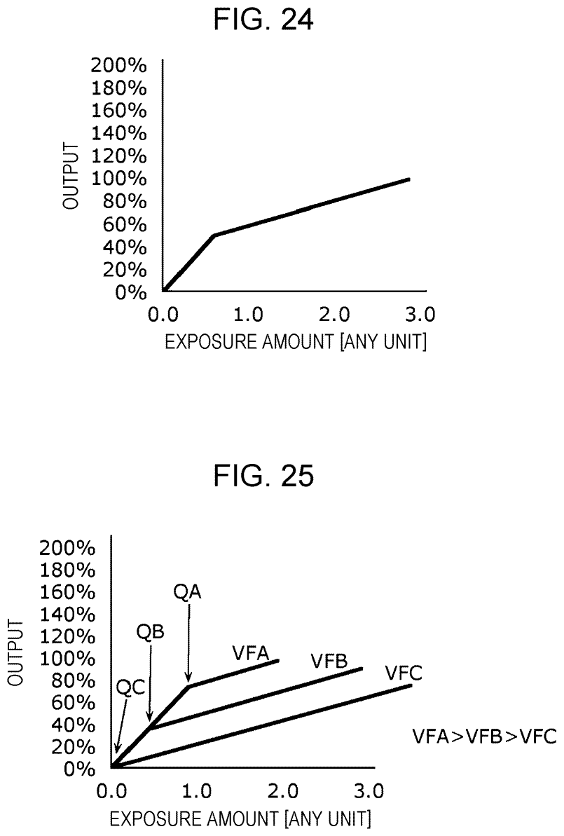

FIG. 23 is a graph schematically illustrating exposure amount-pixel signal output characteristics in the first mode. The horizontal axis of the graph represents an exposure amount of the pixel 24A. The vertical axis represents an output level of a pixel signal output from an amplification transistor 21. Values of the horizontal axis and the vertical axis are normalized. The same is true for FIGS. 24 and 25, which will be described later. As illustrated in FIG. 23, in the first mode, the level of the pixel signal output from the amplification transistor 21 continuously increases as the exposure amount increases. However, the level of the pixel signal peaks out when the exposure amount is 1.

FIG. 24 is a graph schematically illustrating exposure amount-pixel signal output characteristics in the second mode. As illustrated in FIG. 24, in the second mode, an increase of the level of the pixel signal output from the amplification transistor 21 becomes gradual when the exposure amount increases beyond a threshold exposure amount. This is because in a region where the exposure amount is equal to or larger than the threshold exposure amount, the capacitance value of the charge accumulation unit Z is larger and a change of the potential of the charge accumulation unit Z is more gradual accordingly than in a region where the exposure amount is smaller than the threshold exposure amount. The threshold exposure amount is an exposure amount at which the potential of the charge accumulation unit Z becomes the first threshold potential.

As is understood from FIGS. 23 and 24, in the second mode, a signal charge can be accumulated in the charge accumulation unit Z even in a region where the exposure amount is larger, as compared with the first mode. This means that a pixel signal according to an exposure amount can be generated even in a region where an exposure amount is larger. That is, a dynamic range can be enlarged.

In the example illustrated in FIG. 24, when the first transistor 81 is turned on, the first capacitor 71 becomes “visible” as a capacitor. As a result, the first terminal 71a of the first capacitor 71 functions as a part of the charge accumulation unit Z in which a signal charge is accumulated. This increases the capacitance value of the charge accumulation unit Z. Specifically, a capacitance value of the first capacitor 71 is added as the capacitance value of the charge accumulation unit Z.

The imaging device according to the present embodiment can adjust gamma characteristics in the second mode by adjusting the control voltage VF. FIG. 25 is a graph for explaining adjustment of the gamma characteristics. FIG. 25 illustrates cases where the control voltage VF is set to a voltage VFA, a voltage VFB, and voltage VFC.

In the example illustrated in FIG. 25, the voltage VFA is larger than the voltage VFB, and the voltage VFB is larger than the voltage VFC. A threshold exposure amount in a case where the control voltage VF is set as the voltage VFA is an exposure amount QA. A threshold exposure amount in a case where the control voltage VF is set as the voltage VFB is an exposure amount QB. A threshold exposure amount in a case where the control voltage VF is set as the voltage VFC is an exposure amount QC. The exposure amount QA is larger than the exposure amount QB, and the exposure amount QB is larger than the exposure amount QC.

In the second mode, in a dark scene, a plenty of gradations and bits can be allocated to a region where an exposure amount is small by setting the control voltage VF to the voltage VFA. In a bright scene, a plenty of gradations and bits can be allocated to a region where an exposure amount is large by setting the control voltage VF to the voltage VFC. Note that in the first mode, for example, the control voltage VF is set to a voltage larger than the voltage VFA.

As described with reference to FIGS. 23 and 24, the imaging device according to the present embodiment switches, when the control circuit 130 controls the control voltage VF, between the first mode in which the capacitance value of the charge accumulation unit Z does not change and the second mode in which the capacitance value of the charge accumulation unit Z changes. In the second mode, when the potential of the charge accumulation unit Z exceeds a threshold value, the capacitance value of the charge accumulation unit Z increases, and therefore linearity of a change of an output signal level with respect to a change of an exposure amount is lower than that in the first mode. As a result, a slope of an increase of an output with respect to an increase of an exposure amount on a high illuminance side before correction is small.

In view of this, the number of gradations of AD conversion in the second mode illustrated in FIG. 24 may be set larger than the number of gradations of AD conversion in the first mode illustrated in FIG. 23. That is, the control circuit 130 may change the number of gradations of AD conversion performed by an AD conversion circuit 170 in accordance with the control voltage VF. This can suppress degradation of an S/N ratio and enlarge a dynamic range while reducing electric power consumption by a similar principle to the imaging device 101 according to Embodiment 1.

### Other Embodiments

Although the imaging device and imaging method according to the present disclosure have been described above on the basis of the embodiments, the present disclosure is not limited to these embodiments.

For example, although linearity of a magnitude of a pixel signal with respect to an amount of light incident on the photoelectric conversion unit 10A changes depending on the voltage VITO supplied by the voltage supply circuit 126 in Embodiment 1, this is not restrictive. For example, the control circuit 130 may control a voltage value of the reset voltage VRST supplied by the voltage supply circuit 127 as an example of the first voltage, and linearity of a magnitude of a pixel signal with respect to an amount of light incident on the photoelectric conversion unit 10A may change depending on the reset voltage VRST. That is, when a potential difference applied to the photoelectric conversion unit 10A changes by control of the reset voltage VRST, linearity of a magnitude of a pixel signal with respect to an amount of light incident on the photoelectric conversion unit 10A may change. In this case, the voltage VITO is fixed at a predetermined voltage.

Not all of the constituent elements described in the above embodiments need be included in the imaging device, and the imaging device may include only constituent elements necessary for intended operation.

In the above embodiments, a process performed by a specific processing unit may be performed by another processing unit. Furthermore, an order of plural processes may be changed and plural processes may be performed in parallel.

In the above embodiments, each constituent element may be realized by executing a software program suitable for the constituent element. Each constituent element may be realized in a manner such that a program executing unit such as a CPU or a processor reads out and executes a software program recording in a recording medium such as a hard disk or a semiconductor memory.

Each constituent element may be realized by hardware. Each constituent element may be a circuit (or an integrated circuit). These circuits may constitute a single circuit as a whole or may be separate circuits. Furthermore, each of these circuits may be a general-purpose circuit or may be a dedicated circuit.

General or specific aspects of the present disclosure may be implemented as a system, a device, a method, an integrated circuit, a computer program, a computer-readable recording medium such as a CD-ROM, or any selective combination thereof.

For example, the present disclosure may be realized as the imaging device of the above embodiments or may be realized as a control device that controls the imaging device or may be realized as a program for causing a computer to execute an imaging method of the imaging device performed by a control circuit or may be realized as a computer-readable non-transitory recording medium in which such a program is recorded.

Various modification of the embodiments and examples which a person skilled in the art can think of and other embodiments constructed by combining constituent elements in the embodiments and examples are also encompassed within the present disclosure without departing from the spirit of the present disclosure.

The imaging device and imaging method according to the present disclosure are applicable to various camera systems and sensor systems such as a digital still camera, a camera for broadcast, a camera for business purposes, a camera for medical purposes, a surveillance camera, an on-board camera, a digital single-lens reflex camera, and a digital mirrorless interchangeable lens camera.

What is claimed is:

1. An imaging device comprising:
a pixel that includes a photoelectric converter that converts light into a signal charge and a charge accumulator that accumulates the signal charge and outputs a pixel signal according to an amount of the signal charge accumulated in the charge accumulator;
an AD conversion circuit that performs Analog-to-Digital (AD) conversion of the pixel signal output from the pixel; and
a control circuit that sets a number of gradations of digital output of the AD conversion of the pixel signal performed by the AD conversion circuit,
wherein
the photoelectric converter includes a counter electrode, a pixel electrode connected to the charge accumulator, and a photoelectric conversion layer located between the counter electrode and the pixel electrode,
the photoelectric converter has photoelectric conversion characteristics such that photoelectric conversion efficiency changes according to a potential difference between the counter electrode and the pixel electrode,
linearity of a magnitude of the pixel signal with respect to an amount of light incident on the photoelectric converter changes depending on a first voltage supplied from a voltage supply circuit to the pixel, and
the control circuit changes the number of gradations in accordance with the first voltage.

2. The imaging device according to claim 1, wherein
the voltage supply circuit supplies the first voltage to the counter electrode.

3. The imaging device according to claim 1, wherein
the pixel includes a transistor, one of a source and a drain of the transistor being connected to the charge accumulator, and
the voltage supply circuit supplies the first voltage to the other of the source and the drain.

4. The imaging device according to claim 1, wherein
the photoelectric converter has photoelectric conversion characteristics such that a first voltage range, a second voltage range, and a third voltage range characterized by a change of the photoelectric conversion efficiency with respect to the potential difference are present in a reverse bias region, and
in the photoelectric conversion characteristics, the first voltage range is a voltage range immediately before rising of the photoelectric conversion efficiency, the third voltage range is a voltage range in which the photoelectric conversion efficiency is saturated, and the second voltage range is a voltage range between the first voltage range and the third voltage range and is a voltage range in which the photoelectric conversion efficiency increases at a slope larger than the first voltage range and the third voltage range as the potential difference increases.

5. The imaging device according to claim 4, wherein
a width of the first voltage range is 0.5 V or more.

6. The imaging device according to claim 4, wherein
the control circuit sets the number of gradations in a case where the first voltage that makes the potential difference fall within the second voltage range is supplied to the pixel is larger than the number of gradations in a case where the first voltage that makes the potential difference fall within the third voltage range is supplied to the pixel.

7. The imaging device according to claim 1, wherein
the pixel includes a capacitance circuit that changes a capacitance value of the charge accumulator in accordance with a potential of the charge accumulator, and
the voltage supply circuit supplies the first voltage to the capacitance circuit.

8. The imaging device according to claim 7, wherein
the capacitance circuit includes a transistor and a capacitor that are connected in series between a first wire and the charge accumulator,
a gate of the transistor is electrically connected to the charge accumulator, and
the voltage supply circuit supplies the first voltage to the first wire.

9. An imaging method using an imaging device including a pixel that includes a photoelectric converter that converts light into a signal charge and a charge accumulator that accumulates the signal charge and outputs a pixel signal according to an amount of the signal charge accumulated in the charge accumulator and an AD conversion circuit that performs Analog-to-Digital (AD) conversion of the pixel signal output from the pixel, in which linearity of a magnitude of the pixel signal with respect to an amount of light incident on the photoelectric converter changes depending on a first voltage supplied to the pixel, the imaging method comprising:
supplying the first voltage to the pixel; and
setting a number of gradations of a digital output of the AD conversion of the pixel signal performed by the AD conversion circuit in accordance with the first voltage.
